(19) United States
(12) Patent Application Publication
(10) Pub. No.: US 2015/0379955 A1
(43) Pub. Date: Dec. 31, 2015

(54) DISPLAY DEVICE

(71) Applicant: Samsung Display Co., Ltd., Yongin-city (KR)

(72) Inventors: Sang Jin JEON, Suwon-si (KR); II Gon KIM, Seoul (KR); Bong Hyun YOU, Yongin-si (KR); Mee Hye JUNG, Suwon-si (KR); Jun Ki JEONG, Anyang-si (KR)

(21) Appl. No.: 14/578,023

(22) Filed: Dec. 19, 2014

(30) Foreign Application Priority Data
Jun. 30, 2014 (KR) 10-2014-0080986

(51) Int. Cl. G09G 3/36

(52) U.S. Cl. CPC G09G 3/3696; G09G 2330/00; G09G 2320/02

(57) ABSTRACT

A display device is disclosed. In one aspect, the display device includes a display substrate including a display area having a plurality of pixels and a non-display area surrounding the display area. The display device also includes a gate driver formed in the non-display area and configured to provide a plurality of gate signals to the pixels via a plurality of gate lines in response to a plurality of control signals. The display device further includes a signal providing wiring line extending in the first direction in the non-display area and configured to receive one of the control signals. The display device also includes a signal delivering wiring line connected to the gate driver and at least one connection wiring line electrically connecting the signal providing wiring line to the signal delivering wiring line.

### CROSS-REFERENCE TO RELATED APPLICATIONS

This application claims priority from Korean Patent Application No. 10-2014-0080986 filed on Jun. 30, 2014 in the Korean Intellectual Property Office, the disclosure of which is incorporated herein by reference in its entirety.

### BACKGROUND

1. Field

The described technology generally relates to a display device.

2. Description of the Related Technology

Display devices include a display panel and drivers which drive the display panel. The drivers include a data driver which applies a data voltage to each pixel and a gate driver which transmits gate signals to control the delivery of the data voltages to the pixels. In the standard display, the gate driver and the data driver are mounted on a printed circuit board (PCB) in the form of chips and connected accordingly to the display panel or the driver chips are mounted directly on the display panel. However, new alternative structures are being developed. In one such structure, a gate driver that does not require high mobility in a thin-film transistor channel is integrated on a display panel instead of being formed as a separate chip.

Recently, there has been an increasing demand for display devices having a small non-display area surrounding the display area where images are displayed. This is because large non-display areas make the display area look relatively small, thereby restricting the manufacture of tiled display devices.

### SUMMARY OF CERTAIN INVENTIVE ASPECTS

One inventive aspect is a display device having a reduced size non-display area.

However, aspects of the described technology are not restricted to the one set forth herein. The above and other aspects of the described technology will become more apparent to one of ordinary skill in the art to which the described technology pertains by referencing the detailed description of the described technology given below.

Another aspect is a display device comprising a display substrate which comprises a display area having a plurality of pixels and a non-display area surrounding the display area; a plurality of gate lines which extend along a first direction in the display area; a gate driver which is formed in the non-display area and provides gate signals to the pixels through the gate lines in response to control signals; a signal providing wiring line which extends along the first direction in the non-display area and to which any one of the control signals is transmitted; a signal delivering wiring line which extends along the first direction in the display area and is connected to the gate driver; and a connection wiring line which extends in a second direction intersecting the first direction and electrically connects the signal providing wiring line and the signal delivering wiring line.

Another aspect is display device comprising a display substrate which comprises a display area and a non-display area surrounding the display area; a plurality of gate lines which extend along a first direction in the display area; a gate driver which comprises a plurality of stages connected sequentially and outputs a gate signal to the gate lines in response to control signals; a signal providing wiring part which extends along the first direction in the non-display area and to which at least any one of the control signals is transmitted; a signal delivering wiring part which extends along the first direction in the display area and is connected to the gate driver; a connection wiring line which extends along a second direction intersecting the first direction in the display area and connects the signal providing wiring part and the signal delivering wiring part; and a plurality of pixel columns which are located in the display area and receive the gate signal through the gate lines, wherein an n-th stage among the stages comprises: a first sub-stage which is located in the non-display area; and a second sub-stage which is located between two pixel columns adjacent to each other along the second direction in the display area and is connected to the first sub-stage and at least any one of the gate lines, where n is a natural number.

Another aspect is a display device comprising a display substrate including a display area having a plurality of pixels and a non-display area surrounding the display area; a plurality of gate lines extending in a first direction in the display area; a gate driver formed in the non-display area and configured to provide a plurality of gate signals to the pixels via the gate lines in response to a plurality of control signals; a signal providing wiring line extending in the first direction in the non-display area and configured to receive one of the control signals; a signal delivering wiring line extending in the first direction in the display area and connected to the gate driver; and at least one connection wiring line extending in a second direction intersecting the first direction and electrically connecting the signal providing wiring line to the signal delivering wiring line.

In exemplary embodiments, the non-display area comprises first, second, third and fourth non-display areas respectively formed on the upper, lower, left and right sides of the display area, the signal providing wiring line is located in the first non-display area, and the gate driver is located in the third non-display area or the fourth non-display area. The at least one connection wiring line can comprise a plurality of connection wiring lines and the display device can further comprise an auxiliary wiring line extending in the first direction in the second non-display area and connected to each of the connection wiring lines. The signal providing wiring line can be a clock wiring line configured to receive a clock signal or a voltage wiring line configured to receive a low voltage.

In exemplary embodiments, the display device further comprises a plurality of data lines extending in the second direction in the display area, wherein each of the pixels comprises a first subpixel including a first subpixel electrode and a first pixel transistor; and a second subpixel including a second subpixel electrode, a second pixel transistor and a third pixel transistor, wherein the first pixel transistor comprises a control terminal connected to one of the gate lines, an input terminal connected to one of the data lines, and an output terminal connected to the first subpixel electrode, wherein the second pixel transistor comprises a control terminal connected to the same gate line as the first pixel transistor, an input terminal connected to the same data line as the first pixel transistor, and an output terminal connected to the second subpixel electrode, and wherein the third pixel transistor comprises a control terminal connected to the same gate line as the first pixel transistor, an input terminal connected to the output terminal of the second pixel transistor, and an output terminal configured to receive a storage voltage.

Another aspect is a display device comprising a display substrate including a display area and a non-display area surrounding the display area; a plurality of gate lines extending in a first direction in the display area; a gate driver comprising a plurality of stages sequentially connected to each other and respectively configured to output a plurality of gate signals to the gate lines in response to a plurality of control signals; at least one signal providing wiring line extending in the first direction in the non-display area and configured to receive the control signals; at least one signal delivering wiring line extending in the first direction in the display area and connected to the gate driver; at least one connection wiring line extending in a second direction intersecting the first direction in the display area and connecting the signal providing wiring line to the signal delivering wiring line; and a plurality of pixels formed in the display area and arranged in a plurality of columns extending the first direction, wherein the pixels are configured to receive the gate signals via the gate lines, wherein an n-th stage of the gate driver comprises: a first sub-stage located in the non-display area; and a second sub-stage located between adjacent pixel columns in the display area and connected to i) the first sub-stage and ii) one of the gate lines, where n is a natural number.

In exemplary embodiments, the signal delivering wiring line is located between the two adjacent pixel columns and is connected to the first sub-stage and the second sub-stage of the n-th stage. The at least one signal delivering wiring line can comprise a first signal delivering wiring line configured to apply a first clock signal to the n-th stage and a second signal delivering wiring line electrically connected to a control node of the n-th stage and the second sub-stage of the n-th stage can comprise a first transistor having a first control terminal connected to the second signal delivering wiring line, a first input terminal connected to the first signal delivering wiring line, and a first output terminal connected to an n-th gate line. The at least one signal delivering wiring line can further comprise a third signal delivering wiring line configured to apply a low voltage to the n-th stage and a fourth signal delivering wiring line configured to receive a gate signal from an (n+1)th stage and the second sub-stage can further comprise a second transistor having a second control terminal connected to the fourth signal delivering wiring line, a second input terminal connected to the third signal delivering wiring line, and a second output terminal connected to the first output terminal.

In exemplary embodiments, the first sub-stage comprises a third transistor configured to discharge a voltage of an output node connected to the first output terminal to the low voltage in response to a signal synchronized with the first clock signal. The first sub-stage can comprise a fifteenth transistor configured to output the first clock signal as an n-th carry signal in response to a signal transmitted to the first control terminal of the first transistor.

In exemplary embodiments, the first sub-stage of the n-th stage further comprises a tenth transistor having a tenth control terminal configured to receive the first clock signal, a tenth input terminal connected to the first control terminal of the first transistor, and a tenth output terminal connected to the first output terminal of the first transistor; an eleventh transistor configured to maintain a voltage applied to the first control terminal at a low voltage of a carry signal received from a (n−1)th stage in response to a second clock signal; a fifth transistor configured to maintain a voltage applied to the first output terminal at the low voltage in response to the second clock signal; a sixth transistor configured to maintain the voltage applied to the first control terminal at the low voltage in response to a reset signal; and a ninth transistor configured to discharge the voltage applied to the first control terminal to the low voltage in response to a gate signal received from one of the next stages of the n-th stage.

In exemplary embodiments, the non-display area comprises first, second, third and fourth non-display areas respectively formed on the upper, lower, left and right sides of the display area, wherein the signal providing wiring line is located in the first non-display area and wherein the first sub-stage is located in the third non-display area or the fourth non-display area. The at least one signal providing wiring line can comprise a first signal providing wiring line extending in the first direction and configured to receive a first control signal, the at least one signal delivering wiring line can comprise a first signal delivering wiring line extending in the first direction, and the at least one connection wiring line can comprise at least one first connection wiring line extending in the second direction and connecting the first signal providing wiring line to the first signal delivering wiring line. The first control signal can be a first clock signal or a low voltage.

In exemplary embodiments, the at least one first connection wiring line comprises a plurality of first connection wiring lines, wherein the display device further comprises a first auxiliary wiring line extending in the first direction in the second non-display area and wherein the first auxiliary wiring line is connected to each of the first connection wiring lines. The at least one signal providing wiring line can further comprise at least one second signal providing wiring line extending in the first direction and configured to receive a second control signal different from the first control signal, the at least one signal delivering wiring line can comprise a second signal delivering wiring line extending in the first direction, and the at least one connection wiring line can further comprise at least one second connection wiring line extending in the second direction and connecting the second signal providing wiring line to the second signal delivering wiring line. The first control signal can be one of a first clock signal and a low voltage and the second control signal can be the other of the first clock signal and the low voltage. The at least one second connection wiring line can comprise a plurality of second connection wiring lines, the display device can further comprise a second auxiliary wiring line extending in the first direction in the second non-display area and the second auxiliary wiring line can be connected to each of the second connection wiring lines.

In exemplary embodiments, the display device further comprises a plurality of data lines extending in the second direction in the display area, wherein each of pixels comprises a first subpixel which includes a first subpixel electrode and a first pixel transistor; and a second subpixel which includes a second subpixel electrode, a second pixel transistor and a third pixel transistor, wherein the first pixel transistor comprises a control terminal connected to one of the gate lines, an input terminal connected to one of the data lines, and an output terminal connected to the first subpixel electrode, wherein the second pixel transistor comprises a control terminal connected to the same gate line as the first pixel transistor, an input terminal connected to the sane data line as the first pixel transistor, and an output terminal connected to the second subpixel electrode, and wherein the third pixel transistor comprises a control terminal connected to the same gate line as the first pixel transistor, an input terminal connected to the output terminal of the second pixel transistor, and an output terminal configured to receive a storage voltage.

### BRIEF DESCRIPTION OF THE DRAWINGS

FIG. 1 is a schematic plan view of a display device according to an embodiment.

FIG. 2 is an equivalent circuit diagram of an exemplary pixel structure of the display device of FIG. 1.

FIGS. 3 and 4 are exemplary equivalent circuit diagrams of part of the display device of FIG. 1.

FIG. 5 is a schematic plan view of a display device according to another embodiment.

FIGS. 6 and 7 are exemplary equivalent circuit diagrams of part of the display device of FIG. 5.

FIG. 8 is a schematic plan view of a display device according to another embodiment.

FIGS. 9 and 10 are exemplary equivalent circuit diagrams of part of the display device of FIG. 8.

FIG. 11 is a schematic plan view of a display device according to another embodiment.

FIG. 12 is an exemplary equivalent circuit diagram of part of the display device of FIG. 11.

FIG. 13 is a schematic plan view of a display device according to another embodiment.

FIG. 14 is an exemplary equivalent circuit diagram of part of the display device of FIG. 13.

FIG. 15 is a schematic plan view of a display device according to another embodiment.

FIG. 16 is an exemplary equivalent circuit diagram of part of the display device of FIG. 15.

### DETAILED DESCRIPTION OF CERTAIN INVENTIVE EMBODIMENTS

Advantages and features of the described technology and methods of accomplishing the same may be understood more readily by reference to the following detailed description of exemplary embodiments and the accompanying drawings. The described technology may, however, be embodied in many different forms and should not be construed as being limited to the exemplary embodiments set forth herein. Rather, these exemplary embodiments are provided so that this disclosure will be thorough and complete and will fully convey the concept of the described technology to those skilled in the art and the described technology will only be defined by the appended claims. Like numbers refer to like elements throughout. In the drawings, sizes and relative sizes of layers and regions may be exaggerated for the sake of clarity.

It will be understood that when an element or layer is referred to as being “on” another element or layer, it can be directly on the other element or layer or intervening elements or layers may be present.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Like reference numerals refer to like elements throughout the specification.

Embodiments are described herein with reference to plan and cross-section illustrations that are schematic illustrations of idealized embodiments of the described technology. As such, variations from the shapes of the illustrations as a result, for example, of manufacturing techniques and/or tolerances, are to be expected. Thus, the embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the described technology.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the described technology.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Hereinafter, embodiments of the described technology will be described with reference to the attached drawings.

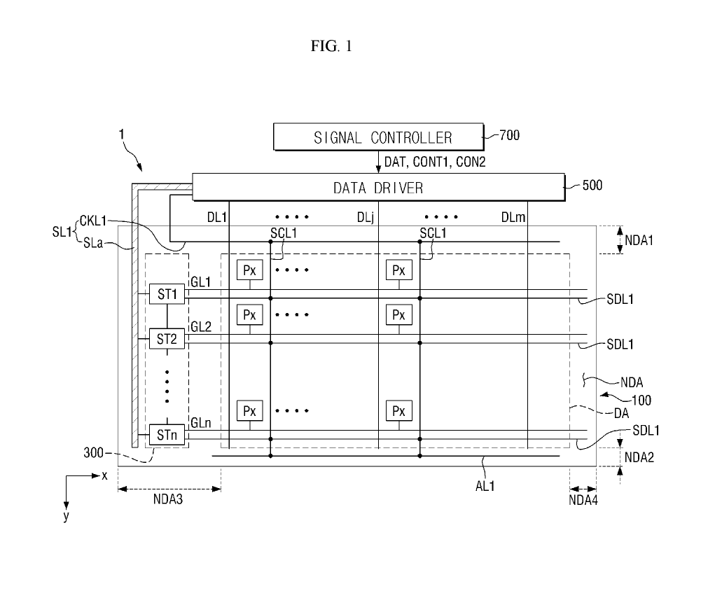

FIG. 1 is a schematic plan view of a display device 1 according to an embodiment.

Referring to FIG. 1, the display device 1 includes a display substrate 100 and a gate driver 300 and further includes a data driver 500 and a signal controller 700.

The display substrate 100 may be a panel that displays images and may be any one of a liquid crystal display (LCD) panel, an electrophoretic display panel (EPD), an organic light-emitting diode (OLED) display panel, an inorganic electroluminescent (EL) display panel, an electro-wetting display (EWD) panel, a field emission display (FED) panel, a surface-conduction electron-emitter display (SED) panel, a plasma display panel (PDP), and a cathode ray tube (CRT). An embodiment where the display substrate 100 is an LCD panel will hereinafter be described as an example, however the described technology is not limited to this embodiment.

The display substrate 100 includes a display area DA where images are displayed and a non-display area NDA surrounding the display area DA.

A plurality of gate lines GL1 through GLn, a plurality of data lines DL1 through DLm, and a plurality of pixels PX connected to the gate lines GL1 through GLn and the data lines DL1 through DLm are arranged at least partially in the display area DA.

The gate lines GL1 through GLn (where n is a natural number) transmit gate signals to the pixels PX and extend in a first direction (or an X direction). The gate lines GL1 through GLn are substantially parallel to each other.

The data lines DL1 through DLm (where m is a natural number) transmit data voltages corresponding to image signals to the pixels PX. The data lines DL1 through DLm intersect the gate lines GL1 through GLn and extend in a second direction (or a Y direction) intersecting the first direction (or the X direction). The data lines DL1 through DLm are substantially parallel to each other.

The pixels PX are arranged in the display area DA to form a matrix.

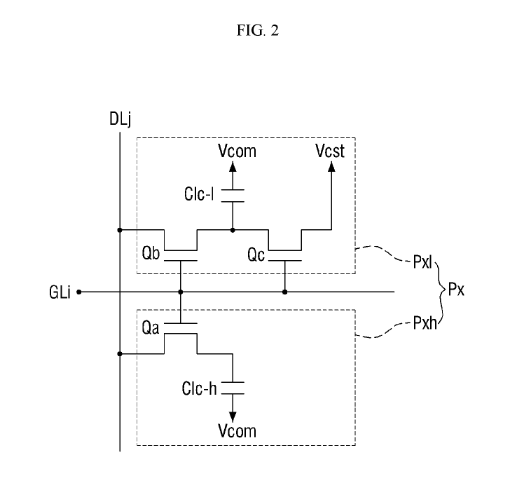

Each of the pixels PX includes a switching element (not illustrated) connected to a gate line and a data line and a pixel electrode (not illustrated) connected to the switching element. The switching element can be implemented as a three-terminal device such as a pixel transistor integrated on the display substrate 100. In some embodiments, the pixel transistor is a thin-film transistor (TFT). The pixels PX will be described in greater detail later with reference to FIG. 2.

The non-display area NDA of the display substrate 100 includes a first non-display area NDA1, a second non-display area NDA2, a third non-display area NDA3, and a fourth non-display area NDA4 defined on upper, lower, left, and right sides of the display area DA as shown in FIG. 1. Each of the first to fourth non-display areas NDA1 to NDA4 forms a part of the non-display area NDA defined based on the display area DA. The non-display area NDA may be blocked from view by a light-blocking member (not illustrated) such as a bezel in order to prevent a user from viewing the non-display area NDA.

The gate driver 300 and a portion SLa of a signal providing wiring part or signal providing wiring line SL1 are located in the non-display area NDA. In an exemplary embodiment, the gate driver 300 and the portion SLa of the signal providing wiring part SL1 are located in the third non-display area NDA3 or the fourth non-display area NDA4. In some embodiments, the data driver 500 is integrated in the non-display area NDA of the display substrate 100 or mounted in the non-display area NDA of the substrate 100 in the form of a plurality of driver integrated circuit (IC) chips.

In addition, a portion of the gate lines GL1 through GLn and a portion of the data lines DL1 through DLm located in the display area DA extends to the non-display area NDA.

The signal controller 700 controls the data driver 500 and the gate driver 300. The signal controller 700 receives an input image signal and an input control signal for controlling the display of the input image signal from an external graphics controller (not illustrated). In some embodiments, the input control signal includes a vertical synchronization signal, a horizontal synchronization signal, a main clock signal, a data enable signal, etc.

The signal controller 700 converts the input image signal into digital image signals DAT by appropriately processing the input image signal based on the input image signal and the input control signal. The signal controller 700 also generates a gate control signal CONT1 and a data control signal CONT2 based on the input image signal and the input control signal. The signal controller 700 sends the gate control signal CONT1 to the gate driver 300 and sends the data control signal CONT2 and the image signals DAT to the data driver 500.

The gate control signal CONT1 can include a scan start signal indicating the start of scanning, at least one clock signal for controlling the output cycle of a gate-on voltage, and at least one low voltage.

The data control signal CONT2 can include a horizontal synchronization start signal indicating the transmission start of image data for one row of pixels PX, a load signal indicating the transmission of data signals to the data lines DL1 through DLm, and a data clock signal. The data control signal CONT2 can further include an inversion signal for inverting the voltage polarity of a data signal with respect to a common voltage (hereinafter, “the voltage polarity of a data signal with respect to a common voltage” will be shortened to “the polarity of a data signal”).

In response to the data control signal CONT2 transmitted from the signal controller 700, the data driver 500 receives the digital image signals DAT for one row of pixels PX, converts the digital image signals DAT into analog data signals by selecting a gray voltage corresponding to each of the digital image signals DAT, and respectively transmits the analog data signals to the corresponding data lines DL1 through DLm.

In response to the gate control signal CONT1 transmitted from the signal controller 700, the gate driver 300 transmits a gate-on voltage to a gate line, thereby turning on the switching element of each pixel PX connected to the gate line. Then, data signals transmitted to the data lines DL1 through DLm are respectively transmitted to the pixels PX via the turned on switching elements.

The signal controller 700 or the data driver 500 can be directly mounted on the display substrate 100 in the form of one or more ICs or IC chips. Alternatively, the signal controller 700 or the data driver 500 can be mounted on a flexible film and then attached accordingly to the display substrate 100. The signal controller 700 or the data driver 500 can also be mounted on a printed circuit board (PCB, not illustrated). Otherwise, the signal controller 700 or the data driver 500 can be integrated on the display substrate 100, together with the signal lines GL1 through GLn and DL1 through DLm and the switching elements of the pixels PX.

The data driver 500 is connected to the data lines DL1 through DLm of the display substrate 100 and applies data voltages to the data lines DL1 through DLm. The data driver 500 receives the data control signal CONT2 and the digital image signals DAT from the signal controller 700, converts the digital image signals DAT into analog data signals by selecting a gray voltage corresponding to each of the digital image signals DAT, and respectively transmits the analog data signals to the corresponding data lines DL1 through DLm. The data driver 500 includes a plurality of data driver IC chips. In addition, the data driver 500 can be integrated on the display substrate 100 together with TFTs located in the display area DA of the display substrate 100 in the same manufacturing process.

The gate driver 300 receives a control signal such as the gate control signal CONT1 from the data driver 500 via the signal providing wiring part SL1 connected to the data driver 500, generates a gate signal composed of a gate-on voltage and a gate-off voltage, and transmits the gate signal to each of the gate lines GL1 through GLn. The gate-on voltage is a voltage that can turn on a pixel transistor and the gate-off voltage is a voltage that can turn off the pixel transistor.

A plurality of control signal lines SL are located in the non-display area NDA. In the non-display area NDA of the display substrate 100 where a portion of the gate driver 300 is located, the control signal lines SL extend in the second direction (or the Y direction).

In some embodiments, the gate driver 300 includes a plurality of stages ST1 through STn arranged sequentially, where n is a natural number. The stages ST1 through STn are shift registers connected to each other in a dependent manner, and each of the stages ST1 through STn includes a plurality of circuit transistors formed together with the switching elements (i.e., the pixel transistors) of the pixels PX by the same manufacturing process. The stages ST1 through STn are respectively connected to the gate lines GL1 through GLn. The stages ST1 through STn generate gate signals and sequentially transmit the gate signals to the gate lines GL1 through GLn. For example, an i^{th} stage STi of the gate driver 300 generates an i^{th} gate signal Gi and provides the i^{th} gate signal Gi to an i^{th} gate line GLi and an (i+1)^{th} stage ST(i+1) generates an (i+1)^{th} gate signal G(i+1) and provides the (i+1)^{th} gate signal G(i+1) to an (i+1)^{th} gate line GL(i+1), where i is a natural number of n−1 or less.

Although not illustrated in the drawing, the gate driver 300 may further include at least one dummy stage (not illustrated) not electrically connected to the gate lines GL1 through GLn. The display substrate 100 may further include a dummy gate line (not illustrated) unrelated to the display of images and the dummy gate line may be connected to the dummy stage.

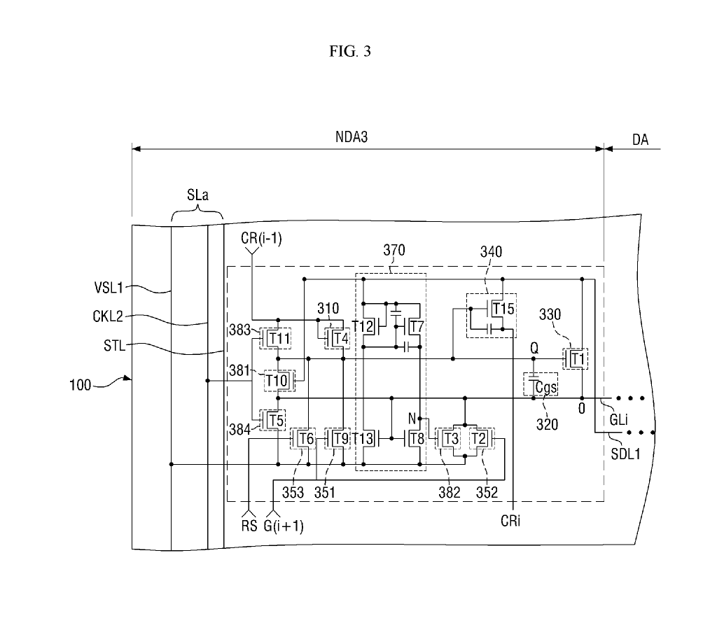

The signal providing wiring part SL1 may include signal providing wiring lines to which a plurality of control signals are transmitted so as to be provided to an i^{th} stage STi. In some embodiments, the signal providing wiring lines include a first voltage wiring line VSL1 (see FIG. 3), a first clock wiring line CKL1, a second clock wiring line CKL2 (see FIG. 3), and a vertical start wiring line STL (see FIG. 3). The control signals includes a low voltage VSS, a first clock signal CK1, a second clock signal CK2, and a vertical start signal STV. The first voltage wiring line VSL1 receives the low voltage VSS, the first clock wiring line CKL1 receives the first clock signal CK1, the second clock wiring line CKL2 receives the second clock signal CK2, and the vertical start wiring line STL receives the vertical start signal STV.

Of the above signal providing wiring lines, the first clock wiring line CKL1 extends in the first direction (or the X direction) in the non-display area NDA. In some embodiments, the first clock wiring line CKL1 is located in the first non-display area NDA1. In some embodiments, the portion SLa of the signal providing wiring part SL1 excluding the first clock wiring line CKL1 includes the first voltage wiring line VSL1, the second clock wiring line CKL2, and the vertical start wiring line STL. As illustrated in FIG. 1, the portion SLa of the signal providing wiring part SL1 is located in the third non-display area NDA3 where the gate driver 300 is located.

A first signal delivering wiring line SDL1 is located in the display area DA. The first signal delivering wiring line SDL1 extends in the first direction (the X direction) and is connected to the gate driver 300. The first signal delivering wiring line SDL1 is designed to deliver the first clock signal CK1, which is provided to the first clock wiring line CKL1, to the gate driver 300. In the FIG. 1 embodiment, a plurality of first signal delivering wiring line SDL1 are provided and the first signal delivering wiring lines SDL1 are respectively connected to the stages ST1 through STn of the gate driver 300. In some embodiments, the number of first signal delivering wiring lines SDL1 equals the number (i.e., n) of gate lines GL1 through GLn.

A first connection wiring line SCL1 is located in the display substrate 100. The first connection wiring line SCL1 extends in the second direction (the Y direction) and electrically connects the first clock wiring line CKL1 to the first signal delivering wiring lines SDL1. One first connection wiring line SCL1 may electrically connect the first clock wiring line CKL1 to two or more first signal delivering wiring lines SDL1 and the first clock signal CK1 transmitted to the first clock wiring line CKL1 is provided to the first signal delivering wiring lines SDL1 via the first connection wiring line SCL1. Most of the first connection wiring line SCL1 are located in the display area DA and portions of the first connection wiring line SCL1 which are connected to the first signal delivering wiring lines SDL1 are located in the display area DA.

In the FIG. 1 embodiment, two or more first connection wiring lines SCL1 are provided in the display area DA. That is, two or more first connection wirings SCL1 are provided as illustrated in the drawing and electrically connect the first clock wiring line CKL1 to the first signal delivering wiring lines SDL1. Accordingly, the first clock signal CK1 transmitted to the first clock wiring line CKL1 can be delivered more stably to the first signal delivering wiring lines SDL1 and the probability of signal variation can be reduced.

When two or more first connection wiring lines SCL1 are provided, a first auxiliary wiring line AL1 is further provided opposite the first clock wiring line CKL1 in some embodiments. In an exemplary embodiment, if the first clock wiring CKL1 is located in the first non-display area NDA1 as illustrated in the drawing and the first auxiliary wiring line AL1 extends in the first direction (the X direction) in the second non-display area NDA2. In addition, each of the first connection wiring lines SCL1 are connected to the first auxiliary wiring line AL1. Accordingly, it is possible to prevent signal delay and signal variation in a portion of the display area DA located at a distance from the first clock wiring CKL1.

FIG. 2 is an equivalent circuit diagram of an exemplary pixel structure of the display device 1 of FIG. 1.

Referring to FIG. 2, the display device 1 of FIG. 1 includes signal lines including a gate line GLi which delivers a gate signal and a data line DLj which delivers a data signal, where j is a natural number of m or less. The display device 1 further includes a pixel PX which is connected to the signal lines.

The pixel PX includes a first pixel transistor Qa, a second pixel transistor Qb, a third pixel transistor Qc, a first liquid crystal capacitor Clc-h, and a second liquid crystal capacitor Clc-1.

In the FIG. 2 embodiment, the pixel PX is divided into a high gray-level subpixel PXh (also referred to as a first subpixel) and a low gray-level subpixel PX1 (also referred to as a second subpixel). The high gray-level subpixel PXh includes the first pixel transistor Qa and the first liquid crystal capacitor Clc-h. The low gray-level subpixel PX1 includes the second pixel transistor Qb, the third pixel transistor Qc, and the second liquid crystal capacitor Clc-1. Here, each of the first, second and third pixel transistors Qa, Qb and Qc are three-terminal elements such as a TFT.

Each of the first and second pixel transistors Qa and Qb is connected to the gate line GLi and the data line DLj and the third pixel transistor Qc is connected to the gate line GLi and an output terminal of the second pixel transistor Qb.

The first pixel transistor Qa includes a control terminal connected to the gate line GLi, an input terminal connected to the data line DLj, and an output terminal connected to the first liquid crystal capacitor Clc-h. In addition, the second pixel transistor Qb includes a control terminal connected to the gate line GLi and an input terminal connected to the data line DLj. The output terminal of the second pixel transistor Qb is connected to an output terminal of the second liquid crystal capacitor Clc-1 and an input terminal of the third pixel transistor Qc. That is, the control terminals of the first and second pixel transistors Qa and Qb are connected to the same gate line GLi and the input terminals of the first and second pixel transistors Qa and Qb are connected to the same data line DLj. The output terminal of the first pixel transistor Qa is connected to the first liquid crystal capacitor Clc-h and the output terminal of the second pixel transistor Qb is connected to an input terminal of the second liquid crystal capacitor Clc-1 and an input terminal of the third pixel transistor Qc.

The third pixel transistor Qc includes a control terminal connected to the same gate line GLi to which the first pixel transistor Qa is connected, an input terminal connected to the output terminal of the second pixel transistor Qb, and an output terminal to which a storage voltage Vcst is applied. That is, the control terminal of the third pixel transistor Qc is connected to the gate line GLi, the input terminal of the third pixel transistor Qc is connected to the output terminal of the second pixel transistor Qb and the second liquid crystal capacitor Clc-1, and the output terminal of the third pixel transistor Qc is connected to a storage voltage line (not illustrated) so as to receive the storage voltage Vcst.

When a gate-on voltage Von is applied to the gate line GLi, the first to third pixel transistors Qa to Qc are turned on. Accordingly, a data voltage applied to the data line DLj is provided to a first subpixel electrode and a second subpixel electrode, which respectively form a terminal of the first liquid crystal capacitor Clc-h and a terminal of the second liquid crystal capacitor Clc-1, via the turned-on first pixel transistor Qa and the turned-on second pixel transistor Qb. However, since the third pixel transistor Qc is turned on, the data voltage applied to the second subpixel electrode is reduced by the difference between the storage voltage Vcst and the input data voltage and the resistance value of the third pixel transistor Qc. The reduced voltage is applied to the second subpixel electrode and the second liquid crystal capacitor Clc-1 is charged with the reduced voltage. That is, the voltage actually applied to the second subpixel electrode is less than the voltage applied to the first subpixel electrode and the voltage charged in the first liquid crystal capacitor Clc-h is different from the voltage charged in the second liquid crystal capacitor Clc-1. Since the voltage charged in the first liquid crystal capacitor Clc-h and the voltage charged in the second liquid crystal capacitor Clc-1 are different, the alignment direction of liquid crystal molecules are different in the first subpixel PXh and the second subpixel PX1. Accordingly, the luminances displayed by the two subpixels PXh and PX1 are different. That is, since the front luminance (the luminance emitted from the front of the display) is displayed as the sum of the luminances displayed by the two subpixels PXh and PX1, the lateral visibility is improved due to the various alignments of the liquid crystals.

In addition, the difference between a kickback voltage of the first subpixel PXh and a kickback voltage of the second subpixel PX1 can be reduced by adjusting the storage voltage Vcst provided to the pixel (e.g., by increasing the storage voltage Vcst). Accordingly, this can prevent the degradation of display quality such as flicker or afterimage.

In the drawing, the gate line GLi is located between the high gray-level subpixel PXh and the low gray-level subpixel PX1. However, this is merely an example, and both the high gray-level subpixel PXh and the low gray-level subpixel PX1 can be located on the upper or lower side of the gate line GLi.

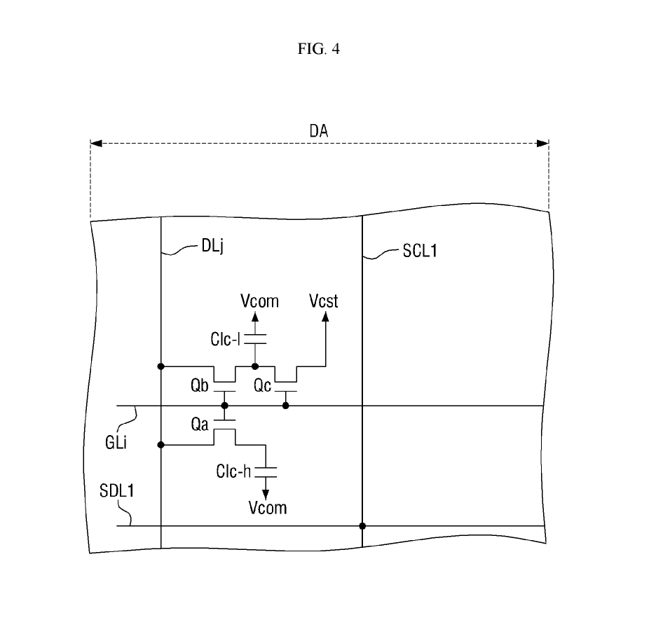

FIGS. 3 and 4 are exemplary equivalent circuit diagrams of part of the display device 1 of FIG. 1. More specifically, FIG. 3 is an equivalent circuit diagram of a stage of the gate driver 300 and FIG. 4 is an equivalent circuit diagram of a pixel PX of the display area DA.

Referring to FIGS. 1 through 4, the portion SLa of the signal providing wiring part SL1 and the stage STi of the gate driver 300 (see FIG. 1) are located in the third non-display area NDA3 of the display substrate 100 and a pixel PX and a first connection wiring line SCL1 connected to the first clock wiring line CKL1 are located in the display area DA. In addition, a first signal delivering wiring line SDL1 connected to the stage STi and the first connection wiring line SCL1 are located in the non-display area NDA and the display area DA.

As described above with reference to FIG. 1, the signal providing wiring part SL1 includes the first voltage wiring line VSL1, the first clock wiring line CKL1, the second clock wiring line CKL2, and the vertical start wiring line STL which deliver a plurality of driving signals to the stage STi. The portion SLa of the signal providing wiring part SL1 includes wiring lines (i.e., the first voltage wiring line VSL1, the second clock wiring line CKL2, and the vertical start wiring line STL) excluding the first clock wiring line CKL1. The first voltage wiring line VSL1 delivers the low voltage VSS, the first clock wiring line CKL1 delivers the first clock signal CK1, the second clock wiring line CKL2 delivers the second clock signal CK2, and the vertical start wiring line STL delivers the vertical start signal STV.

Each of the stages ST1 through STn (see FIG. 1) included in the gate driver 300 (see FIG. 1) includes a plurality of transistors. For example, the i^{th} stage STi includes a buffer unit 310, a charge unit 320, a pull-up unit 330, a carry unit 340, a first discharge unit 351, a second discharge unit 352, a third discharge unit 353, a switching unit 370, a first storage unit 381, a second storage unit 382, a third storage unit 383, and a fourth storage unit 384.

The buffer unit 310 includes a fourth transistor T4. A control terminal and an input terminal of the buffer unit 310 receive an (i−1)^{th} carry signal CR(i−1) transmitted from the previous stage, e.g., the (i−1)^{th} stage ST(i−1), and an output terminal of the buffer unit 310 is connected to a control node Q (or a Q node) of the i^{th} stage STi. The buffer unit 310 charges a step-up capacitor Cgs of the charge unit 320 connected to the control node Q with a high voltage VDD of the (i−1)^{th} carry signal CR(i−1) in response to the high voltage VDD of the (i−1)^{th} carry signal CR(i−1).

The charge unit 320 includes the step-up capacitor Cgs. The charge unit 320 includes a first terminal connected to the control node Q and a second terminal connected to an output node O. The pull-up unit 330 includes a first transistor T1. The pull-up unit 330 includes a control terminal which is electrically connected to the first terminal of the charge unit 320 connected to the control node Q, an input terminal which receives the first clock signal CK1 through the first signal delivering wiring line SDL1, and an output terminal which is connected to the output node O. When a high voltage charged in the step-up capacitor Cgs is applied to the control terminal of the pull-up unit 330, and when the first clock signal CK1 is transmitted to the pull-up unit 330, the pull-up unit 330 is bootstrapped. Here, the step-up capacitor Cgs boosts a charged voltage. The pull-up unit 330 outputs, as the i^{th} gate signal Gi, a high voltage of the first clock signal CK1 to the gate line GLi via the output node O in response to the boosted voltage.

The carry unit 340 includes a fifteenth transistor T15. The carry unit 340 includes a control terminal which is connected to the control node Q, an input terminal which receives the first clock signal CK1 through the first signal delivering wiring line SDL1, and an output terminal which is connected to the next stage, e.g., the (i+1)^{th} stage ST(i+1). In response to a high voltage applied to the control node Q, the carry unit 340 outputs the high voltage of the first clock signal CK1 to the (i+1)^{th} stage ST(i+1) as an i^{th} carry signal CRi.

The first discharge unit 351 includes a ninth transistor T9. The first discharge unit 351 includes a control terminal which is connected to the next stage, e.g., the (i+1)^{th} stage ST(i+1), an input terminal which is connected to the control node Q, and an output terminal which is connected to the first voltage wiring line VSL1. The first discharge unit 351 discharges a voltage applied to the control node Q as the low voltage VSS in response to a high voltage of the (i+1)^{th} gate signal G(i+1) output from the (i+1)^{th} stage ST(i+1).

The second discharge unit 352 includes a second transistor T2. The second discharge unit 352 includes a control terminal which is connected to the (i+1)^{th} stage ST(i+1), an input terminal which is connected to the output node O, and an output terminal which is connected to the first voltage wiring line VSL1. The second discharge unit 352 discharges a voltage applied to the output node O as the low voltage VSS in response to the high voltage of the (i+1)^{th} gate signal G(i+1).

The third discharge unit 353 includes a sixth transistor T6. The third discharge unit 353 includes a control terminal which receives a reset signal RS, an input terminal which is connected to the control node Q, and an output terminal which is connected to the first voltage wiring line VSL1. The third discharge unit 353 discharges a voltage applied to the control node Q as the low voltage VSS in response to a high voltage of the reset signal RS output from a last stage of the gate driver 300 (see FIG. 1).

The switching unit 370 includes a twelfth transistor T12, a seventh transistor T7, a thirteenth transistor T13, and an eighth transistor T8. When a high voltage is applied to the output node O, the eighth and thirteenth transistors T8 and T13 are turned on and discharge a voltage is applied to a node N as the low voltage VSS. When a low voltage is applied to the output node O, the eighth and thirteenth transistors T8 and T13 are turned off. Thus, a signal synchronized with the first clock signal CK1 is transmitted to the node N.

The first storage unit 381 includes a tenth transistor T10. The first storage unit 381 includes a control terminal which receives the first clock signal CK1 via the first signal delivering wiring line SDL1, an input terminal which is connected to the control node Q, and an output terminal which is connected to the output node O. The first storage unit 381 maintains the voltage of the control node Q at the voltage of the output node O in response to the high voltage of the first clock signal CK1.

The second storage unit 382 includes a third transistor T3. The second storage unit 382 includes a control terminal which is connected to the node N, an input terminal which is connected to the output node O, and an output terminal which is connected to the first voltage wiring line VSL1.

The second storage unit 382 maintains the voltage of the output node O at the low voltage VSS in response to a high voltage applied to the node N.

The third storage unit 383 includes an eleventh transistor T11. The third storage unit 383 includes a control terminal which is connected to the second clock wiring line CKL2 to receive the second clock signal CK2, an input terminal which receives the (i−1)^{th} carry signal CR(i−1) from the previous stage, e.g., the (i−1)^{th} stage ST(i−1), and an output terminal which is connected to the control node Q. The third storage unit 383 maintains the voltage of the control node Q at a voltage level of the (i−1)^{th} carry signal CR(i−1) in response to a high voltage of the second clock signal CK2.

The fourth storage unit 384 includes a fifth transistor T5. The fourth storage unit 384 includes a control terminal which receives the second clock signal CK2, an input terminal which is connected to the output node O, and an output terminal which is connected to the first voltage wiring line VSL1. The fourth storage unit 384 maintains the voltage of the output node O at the low voltage VSS in response to the high voltage of the second clock signal CK2.

According to the above-described embodiment, the position of a portion (e.g., the first clock wiring line CKL1) of the signal providing wiring part SL1 for providing control signals to the gate driver 300 is changed with respect to the standard display. Therefore, a portion of the non-display area NDA which corresponds to a side of the display area DA can be reduced in width, which, in turn, reduces the size of the bezel.

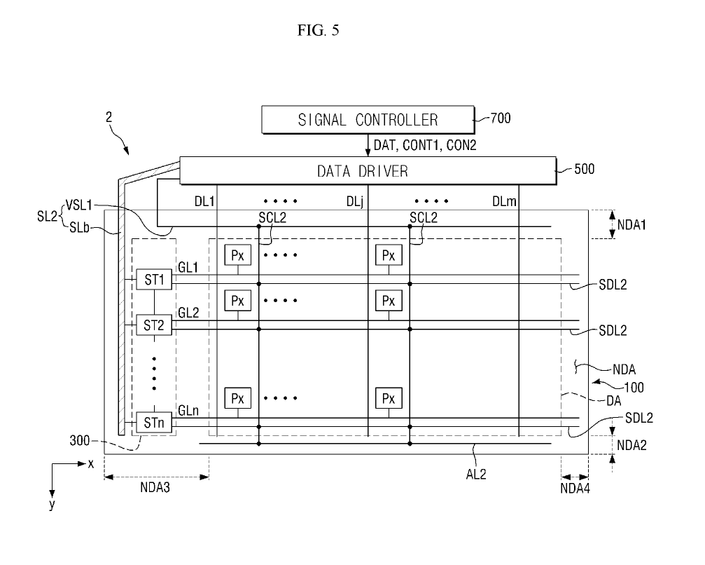

FIG. 5 is a schematic plan view of a display device 2 according to another embodiment.

The major difference between the display device 2 according to the embodiment of FIG. 5 and the display device 1 of FIG. 1 is that the display device 2 includes a signal providing wiring part SL2, a second signal delivering wiring line SDL2, a second connection wiring line SCL2, and a second auxiliary wiring line AL2. Other elements of the display device 2 according to the current embodiment are identical or similar to those of the display device 1 of FIG. 1. For simplicity, descriptions of elements identical to those described above will be omitted or given briefly. The following embodiment will be described, focusing mainly on differences with the previous embodiment.

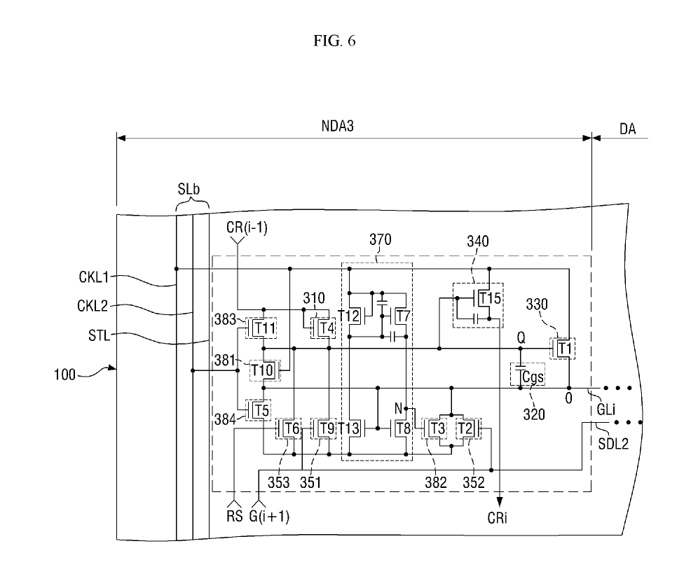

Referring to FIG. 5, the signal providing wiring part SL2 of the display device 2 according to the current embodiment includes signal providing wiring lines which deliver a plurality of control signals to an i^{th} stage STi of a gate driver 300. The signal providing wiring lines include a first voltage wiring line VSL1, a first clock wiring line CKL1 (see FIG. 6), a second clock wiring line CKL2 (see FIG. 6), and a vertical start wiring line STL (see FIG. 6).

The first voltage wiring line VSL1 of the signal providing wiring part SL2 extends in a first direction (or an X direction) in a non-display area NDA. In some embodiments, the first voltage wiring line VSL1 is located in a first non-display area NDA1. In some embodiments, a portion SLb of the signal providing wiring part SL2 excluding the first voltage wiring line VSL1 includes the first clock wiring line CKL1, the second clock wiring line CKL2, and the vertical start wiring line STL. As illustrated in FIG. 5, the portion SLb of the signal providing wiring part SL2 is located in a third non-display area NDA3 where the gate driver 300 is located.

A second signal delivering wiring line SDL2 is located in a display area DA. The second signal delivering wiring line SDL2 extends in the first direction (the X direction) and is connected to the gate driver 300. The second signal delivering wiring line SDL2 is designed to deliver a low voltage, which is provided to the first voltage wiring line VSL1, to the gate driver 300. In some embodiments, a plurality of second signal delivering wiring lines SDL2 are provided and the second signal delivering wiring lines SDL2 are connected to a plurality of stages ST1 through STn of the gate driver 300. In some embodiments, the number of second signal delivering wiring lines SDL2 is equal to the number (i.e., n) of gate lines GL1 through GLn, but is not limited thereto.

A second connection wiring line SCL2 is located in a display substrate 100. The second connection wiring line SCL2 extends in a second direction (a Y direction) and electrically connects the first voltage wiring line VSL1 to the second signal delivering wiring lines SDL2. In some embodiments, one second connection wiring line SCL2 electrically connects the first voltage wiring line VSL1 to two or more second signal delivering wiring lines SDL2 and the low voltage applied to the first voltage wiring line VSL1 is provided to the second signal delivering wiring lines SDL2 via the second connection wiring line SCL2. Most of the second connection wiring line SCL2 can be located in the display area DA and portions of the second connection wiring line SCL2 which are connected to the second signal delivering wiring lines SDL2 can be located in the display area DA.

Two or more second connection wiring lines SCL2 can be provided in the display area DA. Accordingly, the low voltage applied to the first voltage wiring line VSL1 can be delivered more stably to the second signal delivering wiring lines SDL2 and the probability of signal variation can be reduced.

When two or more second connection wiring lines SCL2 are provided, the second auxiliary wiring line AL2 is further provided opposite the first voltage wiring line VSL1 in some embodiments. In an exemplary embodiment, the second auxiliary wiring line AL2 extends in the first direction (the X direction) in the second non-display area NDA2. In addition, each of the second connection wiring lines SCL2 is connected to the second auxiliary wiring line AL2. Accordingly, it is possible to prevent signal delay and signal variation in a portion located relatively far away from the first voltage wiring line VSL1.

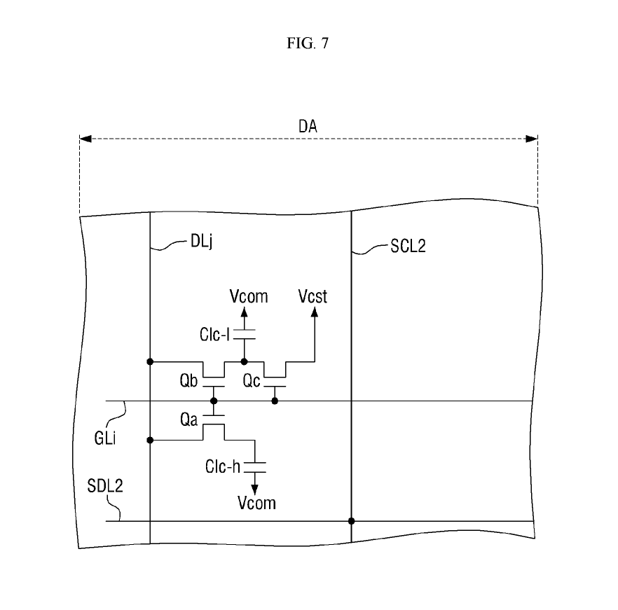

FIGS. 6 and 7 are exemplary equivalent circuit diagrams of part of the display device 2 of FIG. 5. More specifically, FIG. 6 is an equivalent circuit diagram of a stage of the gate driver 300 and FIG. 7 is an equivalent circuit diagram of a pixel PX of the display area DA.

Referring to FIGS. 5 through 7, the portion SLb of the signal providing wiring part SL2 and the stage STi of the gate driver 300 (see FIG. 5) are located in the third non-display area NDA3 of the display substrate 100 and a pixel PX and a second connection wiring line SCL2 connected to the first voltage wiring line VSL1 are located in the display area DA. In addition, a second signal delivering wiring line SDL2 connected to the stage STi and a second connection wiring line SCL2 are located in the non-display area NDA and the display area DA.

As described above with reference to FIG. 5, the signal providing wiring part SL2 includes the first voltage wiring line VSL1, the first clock wiring line CKL1, the second clock wiring line CKL2, and the vertical start wiring line STL which deliver a plurality of driving signals to the stage STi. The portion SLb of the signal providing wiring part SL2 includes the wiring lines (i.e., the first clock wiring line CKL1, the second clock wiring line CKL2, and the vertical start wiring line STL) excluding the first voltage wiring line VSL1.

Each of the stages ST1 through STn (see FIG. 5) included in the gate driver 300 includes a plurality of transistors as described above with reference to FIGS. 3 and 4. For example, the i^{th} stage STi includes a buffer unit 310, a charge unit 320, a pull-up unit 330, a carry unit 340, a first discharge unit 351, a second discharge unit 352, a third discharge unit 353, a switching unit 370, a first storage unit 381, a second storage unit 382, a third storage unit 383, and a fourth storage unit 384. Each element of the gate driver 300 and the operation of each element of the gate driver 300 are identical to those described above with reference to FIGS. 3 and 4, except for the path through which a low voltage and a first clock signal CK1 are received. Therefore, the following description will focus on differences with the previous embodiment.

The pull-up unit 330 includes a first transistor T1. The pull-up unit 330 includes a control terminal which is electrically connected to a first terminal of the charge unit 320 connected to a control node Q, an input terminal which receives the first clock signal CK1 through the first clock wiring line CKL1, and an output terminal which is connected to an output node O.

The carry unit 340 includes a fifteenth transistor T15. The carry unit 340 includes a control terminal which is connected to the control node Q, an input terminal which receives the first clock signal CK1 through the first clock wiring line CKL1, and an output terminal which is connected to the next stage, e.g., an (i+1)^{th} stage ST(i+1).

The first discharge unit 351 includes a ninth transistor T9. The first discharge unit 351 includes a control terminal which is connected to the next stage, e.g., the (i+1)^{th} stage ST(i+1), an input terminal which is connected to the control node Q, and an output terminal which is connected to the second signal delivering wiring line SDL2.

The second discharge unit 352 includes a second transistor T2. The second discharge unit 352 includes a control terminal which is connected to the (i+1)^{th} stage ST(i+1), an input terminal which is connected to the output node O, and an output terminal which is connected to the second signal delivering wiring line SDL2.

The third discharge unit 353 includes a sixth transistor T6. The third discharge unit 353 includes a control terminal which receives a reset signal RS, an input terminal which is connected to the control node Q, and an output terminal which is connected to the second signal delivering wiring line SDL2.

The switching unit 370 includes a twelfth transistor T12, a seventh transistor T7, a thirteenth transistor T13, and an eighth transistor T8. When a high voltage is applied to the output node O, the eighth and thirteenth transistors T8 and T13 are turned on and discharge a voltage applied to a node N as a low voltage VSS. When a low voltage is applied to the output node O, the eighth and thirteenth transistors T8 and T13 are turned off. Thus, a signal synchronized with the first clock signal CK1 can be transmitted to the node N.

The first storage unit 381 includes a tenth transistor T10. The first storage unit 381 includes a control terminal which receives the first clock signal CK1 from the first clock wiring line CKL1, an input terminal which is connected to the control node Q, and an output terminal which is connected to the output node O.

The second storage unit 382 includes a third transistor T3. The second storage unit 382 includes a control terminal which is connected to the node N, an input terminal which is connected to the output node O, and an output terminal which is connected to the second signal delivering wiring line SDL2.

The second storage unit 382 maintains the voltage of the output node O at the low voltage VSS in response to a high voltage applied to the node N.

The third storage unit 383 includes an eleventh transistor T11. The third storage unit 383 includes a control terminal which is connected to the second clock wiring line CKL2 to receive a second clock signal CK2, an input terminal which receives an (i−1)^{th} carry signal CR(i−1) from one of previous stages, e.g., an (i−1)^{th} stage ST(i−1), and an output terminal which is connected to the control node Q.

The fourth storage unit 384 includes a fifth transistor T5. The fourth storage unit 384 includes a control terminal which receives the second clock signal CK2, an input terminal which is connected to the output node O, and an output terminal which is connected to the second signal delivering wiring line SDL2. The fourth storage unit 384 maintains the voltage of the output node O at the low voltage VSS in response to the high voltage of the second clock signal CK2.

According to the above-described embodiment, the position of a portion (e.g., the first voltage wiring line VSL1) of the signal providing wiring part SL2 for providing control signals to the gate driver 300 is changed. Therefore, a portion of the non-display area NDA which corresponds to a side of the display area DA can be reduced in width, which, in turn, reduces the size of a bezel.

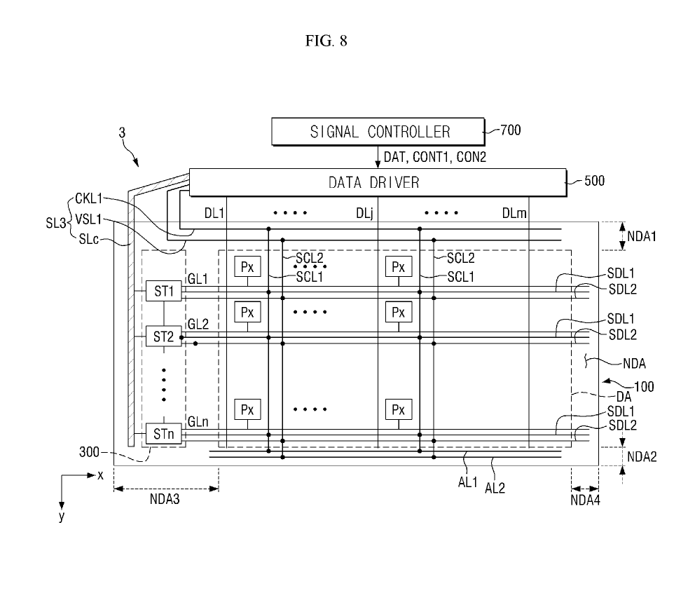

FIG. 8 is a schematic plan view of a display device 3 according to another embodiment. The display device 3 according to the current embodiment is different from the display device 1 of FIG. 1 and the display device 2 of FIG. 5 in the structure of a signal providing wiring part SL3. In addition, the display device 3 according to the current embodiment is different from the display device 1 of FIG. 1 and the display device 2 of FIG. 5 in that it includes a first signal delivering wiring line SDL1, a second signal delivering wiring line SDL2, a first connection wiring line SCL1, a second connection wiring line SCL2, a first auxiliary wiring line AL1, and a second auxiliary wiring line AL2. Other elements of the display device 3 according to the current embodiment are identical or similar to those of the display device 1 of FIG. 1 and the display device 2 of FIG. 5. For simplicity, a description of elements identical to those described above will be omitted or given briefly. The following embodiment will be described focusing mainly on differences with the previous embodiments.

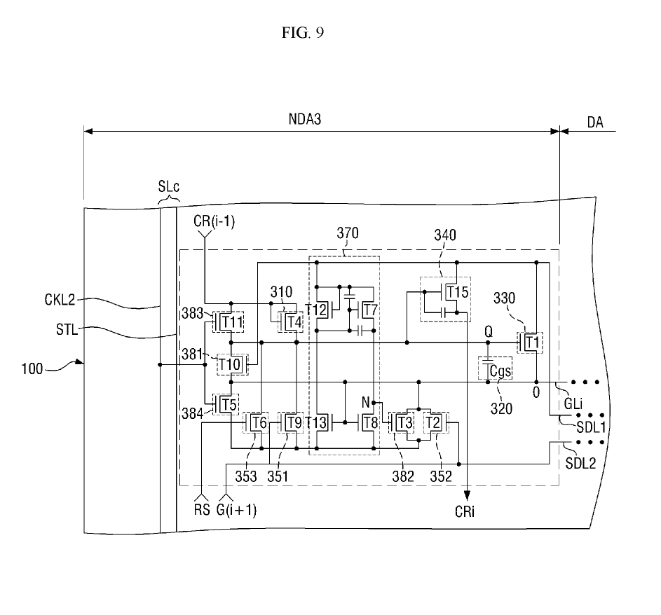

Referring to FIG. 8, the signal providing wiring part SL3 of the display device 3 according to the current embodiment includes signal providing wiring lines which deliver a plurality of control signals to an i^{th} stage STi of a gate driver 300. The signal providing wiring lines include a first voltage wiring line VSL1, a first clock wiring line CKL1, a second clock wiring line CKL2 (see FIG. 9), and a vertical start wiring line STL (see FIG. 9).

Of the above signal providing wiring lines, the first voltage wiring line VSL1 and the first clock wiring line CKL1 extend om a first direction (or an X direction) in a non-display area NDA and are separated from each other. In some embodiments, the first voltage wiring line VSL1 and the first clock wiring line CKL1 are located in a first non-display area NDA1.

In some embodiments, a portion SLc of the signal providing wiring part SL3 excluding the first voltage wiring line VSL1 and the first clock wiring line CKL1 includes the second clock wiring line CKL2 and the vertical start wiring line STL. As illustrated in FIG. 8, the portion SLc of the signal providing wiring part SL3 are located in a third non-display area NDA3 where the gate driver 300 is located.

The first signal delivering wiring line SDL1 and the second signal delivering wiring line SDL2 are located in a display area DA. The first signal delivering wiring line SDL1 and the second signal delivering wiring line SDL2 extend in the first direction (the X direction) and are connected to the gate driver 300. The first signal delivering wiring line SDL1 is designed to deliver a first clock signal CK1, which is transmitted to the first clock wiring line CKL1, to the gate driver 300, and the second signal delivering wiring line SDL2 is designed to deliver a low voltage, which is provided to the first voltage wiring line VSL1, to the gate driver 300.

In some embodiments, a plurality of each of the first signal delivering wiring line SDL1 and the second signal delivering wiring line SDL2 are provided and the first signal delivering wiring lines SDL1 and the second signal delivering wiring lines SDL2 are respectively connected to a plurality of stages ST1 through STn of the gate driver 300. In some embodiments, the number of the first signal delivering wiring lines SDL1 and the number of the second signal delivering wiring lines SDL2 are equal to the number (i.e., n) of gate lines GL1 through GLn, but are not limited thereto.

The first connection wiring line SCL1 and the second connection wiring line SCL2 are located in a display substrate 100. The first connection wiring line SCL1 extends in a second direction (a Y direction) and electrically connects the first clock wiring line CKL1 to the first signal delivering wiring lines SDL1. The second connection wiring line SCL2 extends in the second direction (the Y direction) and electrically connects the first voltage wiring line VSL1 to the second signal delivering wiring lines SDL2. The first connection wiring line SCL1 may be identical to that described above with reference to FIG. 1 and the second connection wiring line SCL2 may be identical to that described above with reference to FIG. 5. Therefore, descriptions of the first connection wiring line SCL1 and the second connection wiring line SCL2 will be omitted.

In some embodiments, two or more first connection wiring lines SCL1 are provided. In these embodiments, the first auxiliary wiring line AL1 is further included opposite the first clock wiring line CKL1 and the first voltage wiring line VSL1 and each of the two or more first connection wiring lines SCL1 is connected to the first auxiliary wiring line AL1.

Likewise, in some embodiments two or more second connection wiring lines SCL2 are provided. In these embodiments, the second auxiliary wiring line AL2 is further provided opposite the first clock wiring line CKL1 and the first voltage wiring line VSL1 and each of the second connection wiring lines SCL2 is connected to the second auxiliary wiring line AL2.

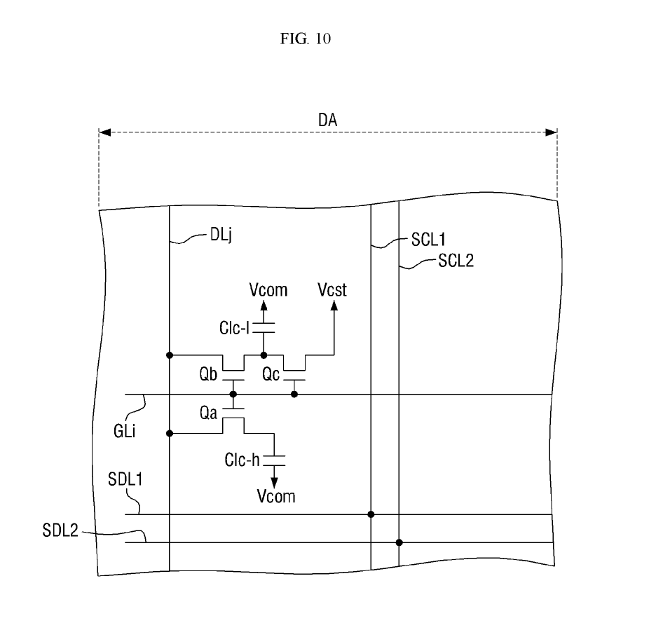

FIGS. 9 and 10 are exemplary equivalent circuit diagrams of part of the display device 3 of FIG. 8. More specifically, FIG. 9 is an equivalent circuit diagram of a stage of the gate driver 300 and FIG. 10 is an equivalent circuit diagram of a pixel PX of the display area DA.

Referring to FIGS. 8 through 10, the portion SLc of the signal providing wiring part SL3 and the stage STi of the gate driver 300 (see FIG. 8) are located in the third non-display area NDA3 of the display substrate 100. In addition, a pixel PX, a first connection wiring line SCL1 connected to the first clock wiring line CKL1 and a second connection wiring line SCL2 connected to the first voltage wiring line VSL1 are located in the display area DA. A first signal delivering line SDL1 connecting the stage STi and the first connection wiring line SCL1 and a second signal delivering wiring line SDL2 connecting the stage STi and the second connection wiring line SCL2 are located in the non-display area NDA and the display area DA.

As described above with reference to FIG. 8, the signal providing wiring part SL3 includes the first voltage wiring line VSL1, the first clock wiring line CKL1, the second clock wiring line CKL2, and the vertical start wiring line STL which deliver a plurality of driving signals to the stage STi. The portion SLc of the signal providing wiring part SL3 includes wiring lines (i.e., the second clock wiring line CKL2 and the vertical start wiring line STL) excluding the first voltage wiring line VSL1 and the first clock wiring line CKL1.

Each of the stages ST1 through STn (see FIG. 8) included in the gate driver 300 include a plurality of transistors as described above with reference to FIGS. 3 and 4. For example, the i^{th} stage STi includes a buffer unit 310, a charge unit 320, a pull-up unit 330, a carry unit 340, a first discharge unit 351, a second discharge unit 352, a third discharge unit 353, a switching unit 370, a first storage unit 381, a second storage unit 382, a third storage unit 383, and a fourth storage unit 384. Each element of the gate driver 300 and the operation of each element of the gate driver 300 are identical to those described above with reference to FIGS. 3 and 4, except for the path through which a low voltage and a first clock signal CK1 are received. Therefore, the following description will focus on differences with the previous embodiment.

The pull-up unit 330 includes a first transistor T1. The pull-up unit 330 includes a control terminal which is electrically connected to a first terminal of the charge unit 320 connected to a control node Q, an input terminal which receives the first clock signal CK1 through the first signal delivering wiring line SDL1, and an output terminal which is connected to an output node O.

The carry unit 340 includes a fifteenth transistor T15. The carry unit 340 includes a control terminal which is connected to the control node Q, an input terminal which receives the first clock signal CK1 through the first signal delivering wiring line SDL1, and an output terminal which is connected to the next stage, e.g., an (i+1)^{th} stage ST(i+1).

The first discharge unit 351 includes a ninth transistor T9. The first discharge unit 351 includes a control terminal which is connected to the next stage, e.g., the (i+1)^{th} stage ST(i+1), an input terminal which is connected to the control node Q, and an output terminal which is connected to the second signal delivering wiring line SDL2.

The second discharge unit 352 includes a second transistor T2. The second discharge unit 352 includes a control terminal which is connected to the (i+1)^{th} stage ST(i+1), an input terminal which is connected to the output node O, and an output terminal which is connected to the second signal delivering wiring line SDL2.

The third discharge unit 353 includes a sixth transistor T6. The third discharge unit 353 includes a control terminal which receives a reset signal RS, an input terminal which is connected to the control node Q, and an output terminal which is connected to the second signal delivering wiring line SDL2.

The switching unit 370 includes a twelfth transistor T12, a seventh transistor T7, a thirteenth transistor T13, and an eighth transistor T8.

The first storage unit 381 includes a tenth transistor T10. The first storage unit 381 includes a control terminal which receives the first clock signal CK1 via the first signal delivering wiring line SDL1, an input terminal which is connected to the control node Q, and an output terminal which is connected to the output node O.

The second storage unit 382 includes a third transistor T3. The second storage unit 382 includes a control terminal which is connected to a node N, an input terminal which is connected to the output node O, and an output terminal which is connected to the second signal delivering wiring line SDL2.

The second storage unit 382 maintains a voltage of the output node O at a low voltage VSS in response to a high voltage applied to the node N.

The third storage unit 383 includes an eleventh transistor T11. The third storage unit 383 includes a control terminal which is connected to the second clock wiring line CKL2 to receive a second clock signal CK2, an input terminal which receives an (i−1)^{th} carry signal CR(i−1) from the previous stage, e.g., an (i−1)^{th} stage ST(i−1), and an output terminal which is connected to the control node Q.

The fourth storage unit 384 includes a fifth transistor T5. The fourth storage unit 384 includes a control terminal which receives the second clock signal CK2, an input terminal which is connected to the output node O, and an output terminal which is connected to the second signal delivering wiring line SDL2.

According to the above-described embodiment, the position of a portion (e.g., the first voltage wiring line VSL1 and the first clock wiring line CKL1) of the signal providing wiring part SL3 for providing control signals to the gate driver 300 is changed compared to the standard display. Therefore, a portion of the non-display area NDA which corresponds to a side of the display area DA can further be reduced in width, which, in turn, further reduces the size of a bezel.

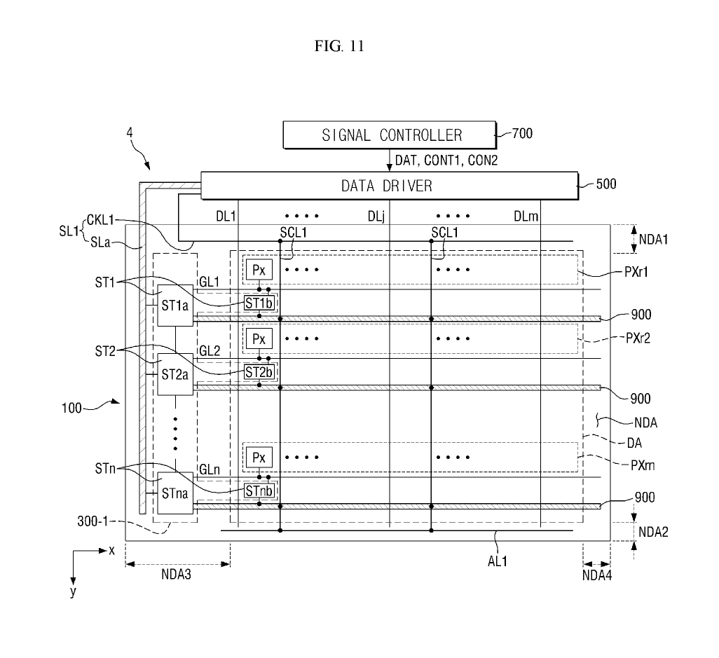

FIG. 11 is a schematic plan view of a display device 4 according to another embodiment. For simplicity, the description of elements identical to those described above with reference to FIGS. 1 through 10 will be omitted or given briefly. The following embodiment will be described, focusing mainly on differences with the previous embodiments.

Referring to FIG. 11, the display device 4 includes a display substrate 100 and a gate driver 300-1 and further includes a data driver 500 and a signal controller 700. The display substrate 100, the data driver 500, and the signal controller 700 are identical to those described above with reference to FIG. 1, and thus a detailed description thereof will be omitted.

A plurality of pixels PX are arranged in a display device DA. The pixels PX are arranged in a first direction (or an X direction) to form a plurality of pixel columns. That is, the display device 4 includes a plurality of pixel columns PXr1 through PXrn arranged adjacent to each other in a second direction (a Y direction). Each of the pixel columns PXr1 through PXrn includes a plurality of pixels PX arranged in the first direction (the X direction) and one pixel column includes an equal number of pixels PX to the number (i.e., m) of at least data lines DL1 through DLm. Each of the pixel columns PXr1 through PXrn is connected to any one of a plurality of gate lines GL1 through GLn. However, the described technology is not limited thereto. For example, each of the pixel columns PXr1 through PXrn may be connected to two or more gate lines or one gate line may be provided for every two or more pixel columns. In these embodiments, the number of the gate lines GL1 through GLn may be different from the number of the pixel columns PXr1 through PXrn.

The gate driver 300-1 includes a plurality of stages ST through STn arranged sequentially, where n is a natural number. In some embodiments, the stages ST1 through STn are shift registers connected to each other in a dependent manner and each of the stages ST1 through STn includes a plurality of circuit transistors formed together with switching elements (i.e., pixel transistors) of the pixels PX by the same manufacturing process. The stages ST1 through STn are respectively connected to the gate lines GL1 through GLn. The stages ST1 through STn generate gate signals and sequentially transmit the gate signals to the gate lines GL1 through GLn. For example, an i^{th} stage STi of the gate driver 300-1 generates an i^{th} gate signal Gi and provides the i^{th} gate signal Gi to an i^{th} gate line GLi and an (i+1)^{th} stage ST(i+1) generates an (i+1)^{th} gate signal G(i+1) and provides the (i+1)^{th} gate signal G(i+1) to an (i+1)^{th} gate line GL(i+1), where i is a natural number of n−1 or less.

At least one of the stages ST1 through STn includes a first sub-stage (ST1a-STna) and a second sub-stage (ST1b-STnb). The first sub-stage (ST1a-STna) and the second sub-stage (ST1b-STnb) included in each stage are electrically connected to each other.

The first sub-stage (ST1a-STna) is located in a non-display area NDA and the second sub-stage (ST1b-STnb) is located in the display area DA. As shown in FIG. 11, the stages ST1 through STn respectively include the first sub-stages ST1a through STna located in the non-display area NDA and the second sub-stages ST1b through STnb located in the display area DA. However, this is merely an example, and the described technology is not limited to this example.

The first sub-stages ST1a through STna are located in the non-display area NDA, and more specifically, in a third non-display area NDA3 in an exemplary embodiment. The first sub-stages ST1a through STna are arranged in a line extending in the second direction (or the Y direction). In FIG. 11, the first sub-stages ST1a through STna are located in the display area NDA on the left side of the display area DA, but the described technology is not limited thereto.

The second sub-stages ST1b through STnb are located in the display area DA and each of the second sub-stages ST1b through STnb is located between two pixel columns formed adjacent to each other in the column direction (or the Y direction).

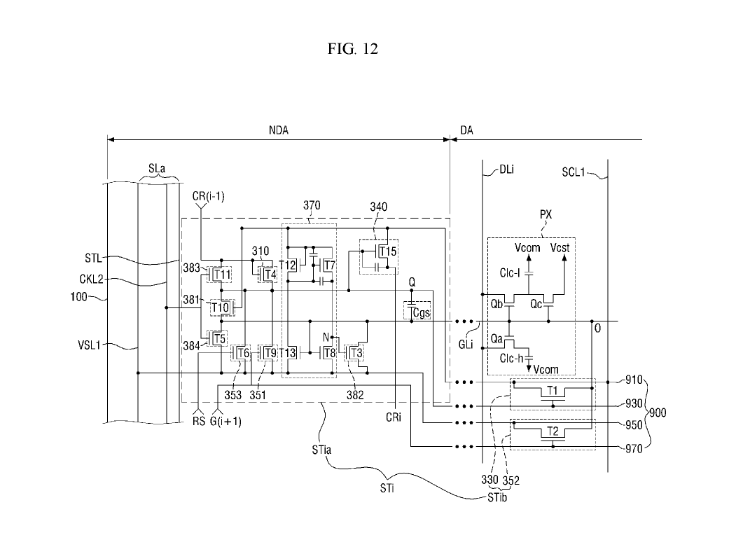

A signal providing wiring line SL1 includes signal providing wiring lines to which a plurality of control signals to be provided to the i^{th} stage STi are transmitted. The signal providing wiring lines include a first voltage wiring line VSL1 (see FIG. 12), a first clock wiring line CKL1, a second clock wiring line CKL2 (see FIG. 12), and a vertical start wiring line STL (see FIG. 12). The control signals include a low voltage VSS, a first clock signal CK1, a second clock signal CK2, and a vertical start signal STV. The first voltage wiring line VSL1 receives the low voltage VSS, the first clock wiring line CKL1 receives the first clock signal CK1, the second clock wiring line CKL2 receives the second clock signal CK2, and the vertical start wiring line STL receives the vertical start signal STV.

Of the above signal providing wiring lines, the first clock wiring line CKL1 extends in the first direction (or the X direction) in the non-display area NDA. In some embodiments, the first clock wiring line CKL1 is located in a first non-display area NDA1. In some embodiments, a portion SLa of the signal providing wiring part SL1 excluding the first clock wiring line CKL1 includes the first voltage wiring line VSL1, the second clock wiring line CKL2, and the vertical start wiring line STL. As illustrated in FIG. 11, the portion SLa of the signal providing wiring part SL1 is located in a third non-display area NDA3 where the first sub-stages ST1a through STna of the gate driver 300-1 are located.

A signal delivering wiring part or signal delivering wiring lines 900 is located in the display area DA. The signal delivering wiring part 900 extends in the first direction (the X direction) and is connected to the gate driver 300-1. The signal delivering wiring part 900 includes signal delivering wiring lines which deliver the first clock signal CK1, which is provided to the first clock wiring line CKL1, to the gate driver 300-1 and electrically connects the first sub-stages ST1a through STna to the second sub-stages ST1b through STnb. In some embodiments, a plurality of signal delivering wiring parts 900 are provided. In some embodiments, the number of the signal delivering wiring parts 900 equals the number (i.e., n) of the gate lines GL1 through GLn.

A first connection wiring line SCL1 is located in the display substrate 100. The first connection wiring line SCL1 extends in the second direction (the Y direction) and electrically connects the first clock wiring line CKL1 to the signal delivering wiring parts 900. One first connection wiring line SCL1 electrically connects the first clock wiring line CKL1 to two or more signal delivering wiring parts 900 and the first clock signal CK1 transmitted to the first clock wiring line CKL1 is provided to the signal delivering wiring parts 900 via the first connection wiring line SCL1. Most of the first connection wiring line SCL1 are located in the display area DA and portions of the first connection wiring line SCL1 which are connected to the signal delivering wiring parts 900 are located in the display area DA.

Two or more first connection wiring lines SCL1 are provided in the display area DA. That is, two or more first connection wirings SCL1 are provided as illustrated in FIG. 11 and electrically connect the first clock wiring line CKL1 to the signal delivering wiring parts 900. Accordingly, the first clock signal CK1 transmitted to the first clock wiring line CKL1 can be delivered more stably to the signal delivering wiring parts 900 and the probability of signal variation can be reduced.

When two or more first connection wiring lines SCL1 are provided, a first auxiliary wiring line AL1 is further provided opposite the first clock wiring line CKL1 in some embodiments. In an exemplary embodiment, when the first clock wiring CKL1 is located in the first non-display area NDA1 as illustrated in FIG. 11, the first auxiliary wiring line AL1 extends in the first direction (the X direction) in the second non-display area NDA2. In addition, each of the first connection wiring lines SCL1 is connected to the first auxiliary wiring line AL1. Accordingly, it is possible to prevent signal delay and signal variation in portions of the display located relatively far away from the first clock wiring CKL1.

FIG. 12 is an exemplary equivalent circuit diagram of part of the display device 4 of FIG. 11.

Referring to FIGS. 11 and 12, the portion SLa of the signal providing wiring part SL1 and the first sub-stage STia of the stage STi of the gate driver 300-1 (see FIG. 11) are located in the third non-display area NDA3 of the display substrate 100. In addition, a pixel PX, a first connection wiring line SCL1 connected to the first clock wiring line CKL1, and the second sub-stage STib of the stage STi are located in the display area DA. Further, a signal delivering wiring part 900 is located in the non-display area NDA and the display area DA.

As described above with reference to FIGS. 3 and 4, the signal providing wiring part SL1 includes the first voltage wiring line VSL1, the first clock wiring line CKL1, the second clock wiring line CKL2, and the vertical start wiring line STL which deliver a plurality of driving signals to the stage STi. The portion SLa of the signal providing wiring part SL1 includes wiring lines (i.e., the first voltage wiring line VSL1, the second clock wiring line CKL2, and the vertical start wiring line STL) excluding the first clock wiring line CKL1. The first voltage wiring line VSL1 delivers the low voltage VSS, the first clock wiring line CKL1 delivers the first clock signal CK1, the second clock wiring line CKL2 delivers the second clock signal CK2, and the vertical start wiring line STL delivers the vertical start signal STV.

Each of the stages ST1 through STn (see FIG. 11) included in the gate driver 300-1 (see FIG. 11) includes a plurality of transistors. For example, the i^{th} stage STi includes a buffer unit 310, a charge unit 320, a pull-up unit 330, a carry unit 340, a first discharge unit 351, a second discharge unit 352, a third discharge unit 353, a switching unit 370, a first storage unit 381, a second storage unit 382, a third storage unit 383, and a fourth storage unit 384. Each element of the i^{th} stage STi and the operation of each element of the i^{th} stage STi are identical to those described above with reference to FIGS. 3 and 4. Therefore, the following description will focus on differences with the previous embodiment.

Of the stage STi, the second sub-stage STib located in the display area DA includes at least any one of the pull-up unit 330 and the second discharge unit 352. In some embodiments, the second sub-stage STib also includes both the pull-up unit 330 and the second discharge unit 352 as illustrated in FIG. 12. The first sub-stage STia includes elements excluding the elements of the second sub-stage STib. Although not illustrated in the drawing, at least some of the buffer unit 310, the charge unit 320, the carry unit 340, the first discharge unit 351, the third discharge unit 353, the switching unit 370, the first storage unit 381, the second storage unit 382, the third storage unit 383, and the fourth storage unit 384 may be further included in the second sub-stage STib. For ease of description, the illustrated embodiment of FIG. 12, where the second sub-stage STib includes both the pull-up unit 330 and the second discharge unit 352 will be described as an example, but the described technology is not limited thereto.

The signal delivering wiring part 900 is located in the display area DA. The signal delivering wiring part 900 is formed adjacent to the second sub-stage STib as illustrated in the drawing. The signal delivering wiring part 900 connects the first sub-stage STia and the second sub-stage STib to each other and delivers the first clock signal CK1, which is transmitted to the first clock wiring line CKL1, to the stage STi. The signal delivering wiring part 900 extends substantially parallel to a gate line GLi.

The signal delivering wiring part 900 includes a first signal delivering wiring line 910, a second signal delivering wiring line 930, a third signal delivering wiring line 950, and a fourth signal delivering wiring line 970.

The first signal delivering wiring line 910 is electrically connected to the first connection wiring line SCL1 so as to receive the first clock signal CK1 transmitted to the first clock wiring line CKL1.

The second signal delivering wiring line 930 is electrically connected to a control node Q so as to receive a voltage applied to the control node Q.

The third signal delivering wiring line 950 is electrically connected to the first voltage wiring line VSL1 so as to receive the low voltage VSS.

The fourth signal delivering wiring line 970 receives an (i+1)^{th} gate signal G(i+1) from the (i+1)^{th} stage ST(i+1) (the next stage of the i^{th} stage STi).

A control terminal of the first transistor T1 is connected to the second signal delivering wiring line 930 so as to receive a voltage applied to the control node Q. In addition, an input terminal of the first transistor T1 is connected to the first signal delivering wiring line 910 so as to receive the first clock signal CK1 and an output terminal of the first transistor T1 is connected to the gate line GLi.

A control terminal of the second transistor T2 is connected to the fourth signal delivering wiring line 970 which is connected to the (i+1)^{th} stage ST(i+1) so as to receive the (i+1)^{th} gate signal G(i+1). In addition, an input terminal of the second transistor T2 is connected to the output terminal of the first transistor T1 or the gate line GLi and an output terminal of the second transistor T2 is connected to the third signal delivering wiring line 950 so as to receive the low voltage VSS.

According to at least one embodiment, part of the gate driver 300-1 is placed in the display area DA to reduce the non-display area NDA, thereby reducing the size of a bezel. In addition, the position of a portion (e.g., the first clock wiring line CKL1) of the signal providing wiring part SL1 for providing control signals to the gate driver 300-1 is changed with respect to the standard display. Therefore, a portion of the non-display area NDA which corresponds to a side of the display area DA can further be reduced in width, which, in turn, further reduces the size of the bezel.

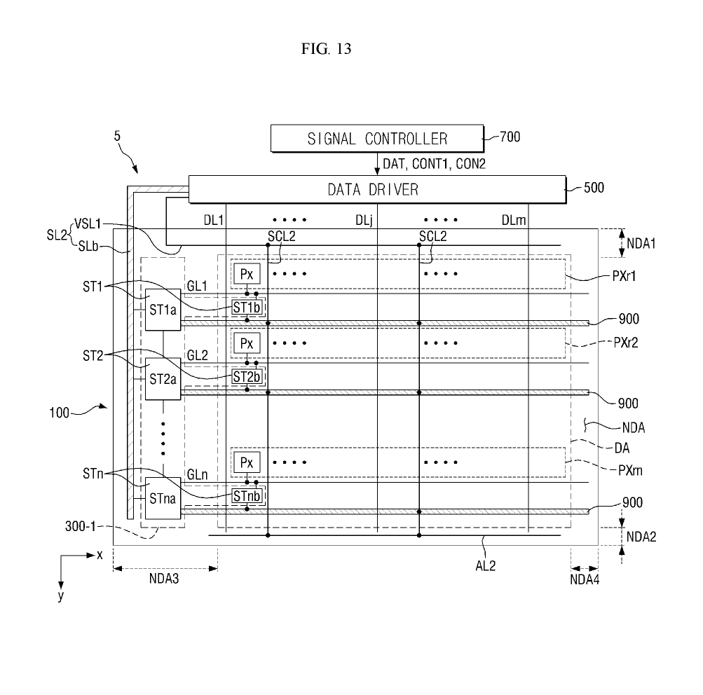

FIG. 13 is a schematic plan view of a display device 5 according to another embodiment. The major difference between the display device 5 according to the current embodiment and the display device 4 of FIG. 11 is that the display device 5 according to the current embodiment includes a signal providing wiring part SL2, a second connection wiring line SCL2, and a second auxiliary wiring line AL2. Other elements of the display device 5 according to the current embodiment are identical or similar to those of the display device 4 of FIG. 11. For simplicity, descriptions of elements identical to those described above will be omitted or given briefly. The following embodiment will be described, focusing mainly on differences with the previous embodiments.

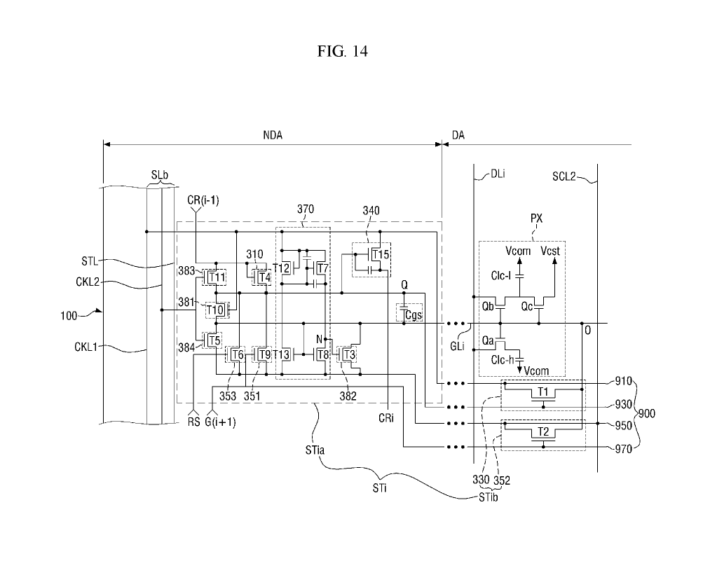

Referring to FIG. 13, the signal providing wiring part SL2 of the display device 5 according to the current embodiment includes signal providing wiring lines which deliver a plurality of control signals to a plurality of stages ST1 through STn of a gate driver 300-1. The signal providing wiring lines include a first voltage wiring line VSL1, a first clock wiring line CKL1 (see FIG. 14), a second clock wiring line CKL2 (see FIG. 14), and a vertical start wiring line STL (see FIG. 14). The signal providing wiring part SL2 according to the current embodiment is substantially identical or similar to that described above with reference to FIG. 5.

The first voltage wiring line VSL1 of the signal providing wiring part SL2 extend in a first direction (or an X direction) in a non-display area NDA. In some embodiments, the first voltage wiring line VSL1 is located in a first non-display area NDA1.

A signal delivering wiring part 900 is located in a display area DA. The signal delivering wiring part 900 extends in the first direction (the X direction) and is connected to the gate driver 300-1.

The second connection wiring line SCL2 is located in a display substrate 100. The second connection wiring line SCL2 extends in a second direction (a Y direction) and electrically connects the first voltage wiring line VSL1 to the signal delivering wiring part 900. One second connection wiring line SCL2 electrically connects the first voltage wiring line VSL1 to two or more signal delivering wiring parts 900 and a low voltage applied to the first voltage wiring line VSL1 is provided to the signal delivering wiring parts 900 via the second connection wiring line SCL2. Most of the second connection wiring line SCL2 is located in the display area DA and portions of the second connection wiring line SCL2 which are connected to the signal delivering wiring parts 900 are located in the display area DA.

Two or more second connection wiring lines SCL2 are provided in the display area DA. Accordingly, the low voltage applied to the first voltage wiring line VSL1 can be delivered more stably to the signal delivering wiring parts 900 and the probability of signal variation can be reduced.

When two or more second connection wiring lines SCL2 are provided, the second auxiliary wiring line AL2 is further provided opposite the first voltage wiring line VSL1 in some embodiments. In an exemplary embodiment, the second auxiliary wiring line AL2 extends in the first direction (the X direction) in a second non-display area NDA2. In addition, each of the second connection wiring lines SCL2 is connected to the second auxiliary wiring line AL2. Accordingly, it is possible to prevent signal delay and signal variation in a portion located relatively far away from the first voltage wiring line VSL1.

FIG. 14 is an exemplary equivalent circuit diagram of part of the display device 5 of FIG. 13.

Referring to FIGS. 13 and 14, a portion SLb of the signal providing wiring part SL2 and a first sub-stage STia of a stage STi of the gate driver 300-1 (see FIG. 13) are located in the third non-display area NDA3 of the display substrate 100. In addition, a pixel PX, a second connection wiring line SCL2 connected to the first voltage wiring line VSL1, and a second sub-stage STib of the stage STi are located in the display area DA. Further, a signal delivering wiring part 900 is located in the non-display area NDA and the display area DA.

As described above with reference to FIGS. 6 and 7, the signal providing wiring part SL2 includes the first voltage wiring line VSL1, the first clock wiring line CKL1, the second clock wiring line CKL2, and the vertical start wiring line STL which deliver a plurality of driving signals to the stage STi. The portion SLb of the signal providing wiring part SL2 includes wiring lines (i.e., the first clock wiring line CKL1, the second clock wiring line CKL2, and the vertical start wiring line STL) excluding the first voltage wiring line VSL1.

Each of the stages ST1 through STn (see FIG. 13) included in the gate driver 300-1 includes a plurality of transistors. For example, the i^{th} stage STi includes a buffer unit 310, a charge unit 320, a pull-up unit 330, a carry unit 340, a first discharge unit 351, a second discharge unit 352, a third discharge unit 353, a switching unit 370, a first storage unit 381, a second storage unit 382, a third storage unit 383, and a fourth storage unit 384. Each element of the gate driver 300-1 and the operation of each element of the gate driver 300-1 are identical to those described above with reference to FIGS. 3 and 4, and thus a detailed description thereof will be omitted. In addition, the first sub-stage STia and the second sub-stage STib are identical to those described above with reference to FIG. 12, and thus a detailed description thereof will be omitted.

The signal delivering wiring part 900 is further located in the display area DA. The signal delivering wiring part 900 is formed adjacent to the second sub-stage STib as illustrated in the drawing. The signal delivering wiring part 900 connects the first sub-stage STia to the second sub-stage STib and delivers a low voltage VSS, which is applied to the first voltage wiring line VSL1, to the stage STi. The signal delivering wiring part 900 extends substantially parallel to a gate line GLi.

The signal delivering wiring part 900 includes a first signal delivering wiring line 910, a second signal delivering wiring line 930, a third signal delivering wiring line 950, and a fourth signal delivering wiring line 970.

The first signal delivering wiring line 910 is electrically connected to the first clock wiring line CKL1 so as to receive a first clock signal CK1.

The second signal delivering wiring line 930 is electrically connected to a control node Q so as to receive a voltage applied to the control node Q.

The third signal delivering wiring line 950 is electrically connected to the second connection wiring line SCL2 so as to receive the low voltage VSS applied to the first voltage wiring line VSL1.

The fourth signal delivering wiring line 970 receives an (i+1)^{th} gate signal G(i+1) from an (i+1)^{th} stage ST(i+1) (the next stage of the i^{th} stage STi).

According to at least one embodiment, part of the gate driver 300-1 is placed in the display area DA to reduce the non-display area NDA, thereby reducing a bezel of the display device 5. In addition, the position of a portion (e.g., the first voltage wiring line VSL1) of the signal providing wiring part SL2 for providing control signals to the gate driver 300-1 is changed with respect to the standard display. Therefore, a portion of the non-display area NDA which corresponds to a side of the display area DA can further be reduced in width, which, in turn, further reduces the size of the bezel.

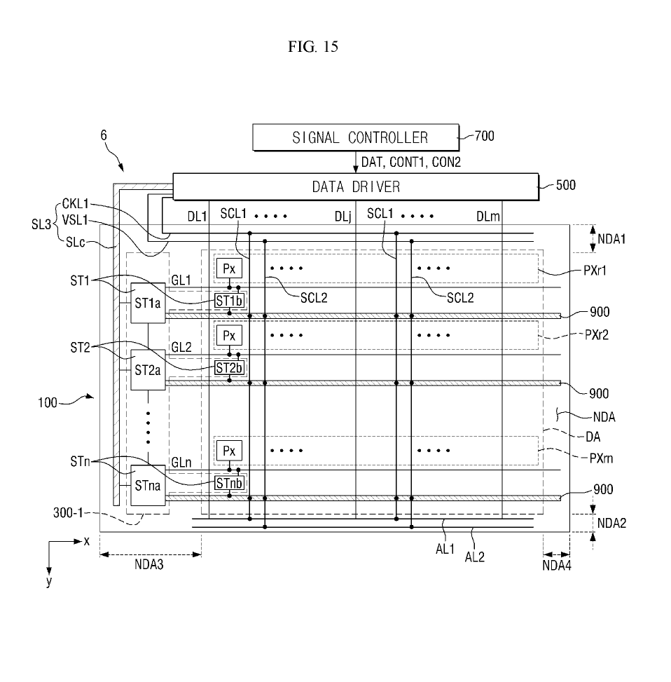

FIG. 15 is a schematic plan view of a display device 6 according to another embodiment. The display device 6 according to the current embodiment is different from the display device 4 of FIG. 11 and the display device 5 of FIG. 13 in that it includes a signal providing wiring part SL3, a first connection wiring line SCL1, a second connection wiring line SCL2, a first auxiliary wiring line AL1 and a second auxiliary wiring line AL2. Other elements of the display device 6 according to the current embodiment are identical or similar to those of the display device 4 of FIG. 11 and those of the display device 5 of FIG. 13. For simplicity, descriptions of elements identical to those described above will be omitted or given briefly. The following embodiment will be described, focusing mainly on differences with the previous embodiments.

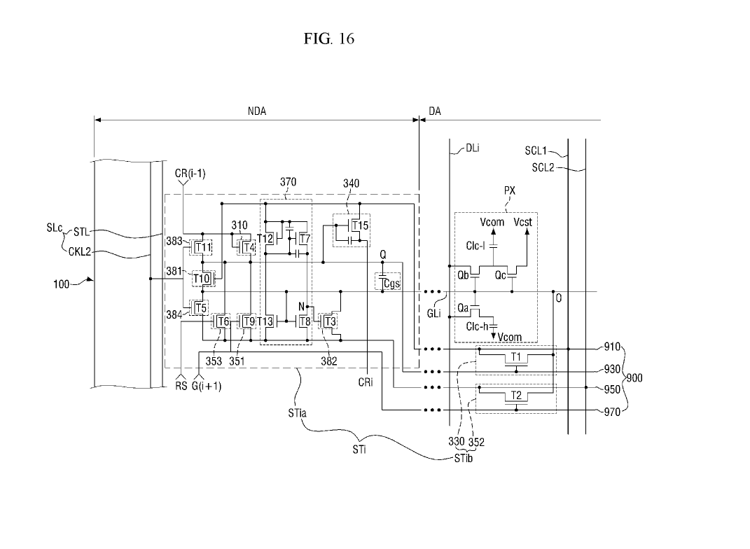

Referring to FIG. 15, the signal providing wiring part SL3 of the display device 6 according to the current embodiment includes signal providing wiring lines which deliver a plurality of control signals to an i^{th} stage STi of a gate driver 300-1. The signal providing wiring lines include a first voltage wiring line VSL1, a first clock wiring line CKL1, a second clock wiring line CKL2 (see FIG. 16), and a vertical start wiring line STL (see FIG. 16). The signal providing wiring part SL3 according to the current embodiment are substantially identical or similar to that described above with reference to FIG. 8.

Of the above signal providing wiring lines, the first voltage wiring line VSL1 and the clock wiring line CKL1 extend in a first direction (or an X direction) in a non-display area NDA and are separated from each other. In some embodiments, the first voltage wiring line VSL1 and the first clock wiring line CKL1 are located in a first non-display area NDA1.

In some embodiments, a portion SLc of the signal providing wiring part SL3 excluding the first voltage wiring line VSL1 and the first clock wiring line CKL1 includes the second clock wiring line CKL2 and the vertical start wiring line STL. The portion SLc of the signal providing wiring part SL3 is located in a third non-display area NDA3 where first sub-stages ST1a through STna of the gate driver 300-1 of FIG. 8 are located.

A signal delivering wiring part 900 is located in a display area DA. The signal delivering wiring part 900 extends in the first direction (the X direction) and is connected to the gate driver 300-1.

The first connection wiring line SCL1 and the second connection wiring line SCL2 are located in a display substrate 100. The first connection wiring line SCL1 extends in a second direction (a Y direction) and electrically connects the first clock wiring line CKL1 to the signal delivering wiring part 900. The second connection wiring line SCL2 extends in the second direction (the Y direction) and electrically connects the first voltage wiring line VSL1 to the signal delivering wiring part 900. The first connection wiring line SCL1 is identical to that described above with reference to FIGS. 11 and 12, and thus a detailed description thereof will be omitted. In addition, the second connection wiring line SCL2 is identical to that described above with reference to FIGS. 13 and 14, and thus a detailed description thereof will be omitted.

In some embodiments, two or more first connection wiring lines SCL1 are provided. In these embodiments, the first auxiliary wiring line AL1 is further provided opposite the first clock wiring line CKL1 and the first voltage wiring line VSL and each of the two or more first connection wiring lines SCL1 are connected to the first auxiliary wiring line AL1.

Likewise, two or more second connection wiring lines SCL2 are provided in some embodiments. In these embodiments, the second auxiliary wiring line AL2 is further provided opposite the first clock wiring line CKL1 and the first voltage wiring line VSL1 and each of the second connection wiring lines SCL2 are connected to the second auxiliary wiring line AL2.

FIG. 16 is an exemplary equivalent circuit diagram of part of the display device 6 of FIG. 15.

Referring to FIGS. 15 and 16, the portion SLc of the signal providing wiring part SL3 and a first sub-stage STia of the stage STi of the gate driver 300-1 (see FIG. 15) are located in the third non-display area NDA3 of the display substrate 100. In addition, a pixel PX, a first connection wiring line SCL1 connected to the first clock wiring line CKL1, a second connection wiring line SCL2 connected to the first voltage wiring line VSL1, and a second sub-stage STib of the stage STi are located in the display area DA. Further, a signal delivering wiring part 900 is located in the non-display area NDA and the display area DA.

As described above with reference to FIGS. 9 and 10, the signal providing wiring part SL3 includes the first voltage wiring line VSL1, the first clock wiring line CKL1, the second clock wiring line CKL2, and the vertical start wiring line STL which deliver a plurality of driving signals to the stage STi. The portion SLc of the signal providing wiring part SL3 includes wiring lines (i.e., the second clock wiring line CKL2 and the vertical start wiring line STL) excluding the first voltage wiring line VSL1 and the first clock wiring line CKL1.

Each of a plurality of stages ST1 through STn (see FIG. 13) included in the gate driver 300-1 includes a plurality of transistors. For example, the i^{th} stage STi includes a buffer unit 310, a charge unit 320, a pull-up unit 330, a carry unit 340, a first discharge unit 351, a second discharge unit 352, a third discharge unit 353, a switching unit 370, a first storage unit 381, a second storage unit 382, a third storage unit 383, and a fourth storage unit 384.

The signal delivering wiring part 900 includes a first signal delivering wiring line 910, a second signal delivering wiring line 930, a third signal delivering wiring line 950, and a fourth signal delivering wiring line 970.

The first signal delivering wiring line 910 is electrically connected to the first connection wiring line SCL1 so as to receive a first clock signal CK1 transmitted to the first clock wiring line CKL1.

The second signal delivering wiring line 930 is electrically connected to a control node Q so as to receive a voltage applied to the control node Q.

The third signal delivering wiring line 950 is electrically connected to the second connection wiring line SCL2 so as to receive a low voltage VSS applied to the first voltage wiring line VSL1.

The fourth signal delivering wiring line 970 receives an (i+1)^{th} gate signal G(i+1) from an (i+1)^{th} stage ST(i+1) (the next stage of the i^{th} stage STi).

According to at least one embodiment, part of the gate driver 300-1 is placed in the display area DA to reduce the non-display area NDA, thereby reducing a bezel of the display device 6. In addition, the position of a portion (e.g., the first clock wiring line CKL1 and the first voltage wiring line VSL1) of the signal providing wiring part SL3 for providing control signals to the gate driver 300-1 is changed with respect to the standard display. Therefore, a portion of the non-display area NDA which corresponds to a side of the display area DA can further be reduced in width, which, in turn, further reduces the size of the bezel.

At least one embodiment of the described technology provides at least one of the following advantages.

The described technology can provide a display device having a reduced non-display area.

However, the effects of the described technology are not restricted to the one set forth herein. The above and other effects of the described technology will become more apparent to one of daily skill in the art to which the described technology pertains by referencing the claims.

While the inventive technology has been particularly shown and described with reference to exemplary embodiments thereof, it will be understood by those of ordinary skill in the art that various changes in form and detail may be made therein without departing from the spirit and scope of the invention as defined by the following claims. The exemplary embodiments should be considered in a descriptive sense only and not for purposes of limitation.

What is claimed is:

1. A display device, comprising:
a display substrate including a display area having a plurality of pixels and a non-display area surrounding the display area;
a plurality of gate lines extending in a first direction in the display area;
a gate driver formed in the non-display area and configured to provide a plurality of gate signals to the pixels via the gate lines in response to a plurality of control signals;
a signal providing wiring line extending in the first direction in the non-display area and configured to receive one of the control signals;
a signal delivering wiring line extending in the first direction in the display area and connected to the gate driver; and
at least one connection wiring line extending in a second direction intersecting the first direction and electrically connecting the signal providing wiring line to the signal delivering wiring line.

2. The display device of claim 1, wherein the non-display area comprises first, second, third and fourth non-display areas respectively formed on the upper, lower, left and right sides of the display area, wherein the signal providing wiring line is located in the first non-display area, and wherein the gate driver is located in the third non-display area or the fourth non-display area.

3. The display device of claim 2, wherein the at least one connection wiring line comprises a plurality of connection wiring lines and wherein the display device further comprises an auxiliary wiring line extending in the first direction in the second non-display area and connected to each of the connection wiring lines.

4. The display device of claim 1, wherein the signal providing wiring line is a clock wiring line configured to receive a clock signal or a voltage wiring line configured to receive a low voltage.

5. The display device of claim 1, further comprising a plurality of data lines extending in the second direction in the display area, wherein each of the pixels comprises:
a first subpixel including a first subpixel electrode and a first pixel transistor; and
a second subpixel including a second subpixel electrode, a second pixel transistor and a third pixel transistor,
wherein the first pixel transistor comprises a control terminal connected to one of the gate lines, an input terminal connected to one of the data lines, and an output terminal connected to the first subpixel electrode,
wherein the second pixel transistor comprises a control terminal connected to the same gate line as the first pixel transistor, an input terminal connected to the same data line as the first pixel transistor, and an output terminal connected to the second subpixel electrode, and
wherein the third pixel transistor comprises a control terminal connected to the same gate line as the first pixel transistor, an input terminal connected to the output terminal of the second pixel transistor, and an output terminal configured to receive a storage voltage.

6. A display device, comprising:
a display substrate including a display area and a non-display area surrounding the display area;
a plurality of gate lines extending in a first direction in the display area;
a gate driver comprising a plurality of stages sequentially connected to each other and respectively configured to output a plurality of gate signals to the gate lines in response to a plurality of control signals;
at least one signal providing wiring line extending in the first direction in the non-display area and configured to receive the control signals;
at least one signal delivering wiring line extending in the first direction in the display area and connected to the gate driver;
at least one connection wiring line extending in a second direction intersecting the first direction in the display area and connecting the signal providing wiring line to the signal delivering wiring line; and
a plurality of pixels formed in the display area and arranged in a plurality of columns extending the first direction, wherein the pixels are configured to receive the gate signals via the gate lines,
wherein an n-th stage of the gate driver comprises:
a first sub-stage located in the non-display area; and
a second sub-stage located between adjacent pixel columns in the display area and connected to i) the first sub-stage and ii) one of the gate lines, where n is a natural number.

7. The display device of claim 6, wherein the signal delivering wiring line is located between the two adjacent pixel columns and is connected to the first sub-stage and the second sub-stage of the n-th stage.

8. The display device of claim 7, wherein the at least one signal delivering wiring line comprises a first signal delivering wiring line configured to apply a first clock signal to the n-th stage and a second signal delivering wiring line electrically connected to a control node of the n-th stage and wherein the second sub-stage of the n-th stage comprises a first transistor having a first control terminal connected to the second signal delivering wiring line, a first input terminal connected to the first signal delivering wiring line, and a first output terminal connected to an n-th gate line.

9. The display device of claim 8, wherein the at least one signal delivering wiring line further comprises a third signal delivering wiring line configured to apply a low voltage to the n-th stage and a fourth signal delivering wiring line configured to receive a gate signal from an (n+1)th stage and wherein the second sub-stage further comprises a second transistor having a second control terminal connected to the fourth signal delivering wiring line, a second input terminal connected to the third signal delivering wiring line, and a second output terminal connected to the first output terminal.

10. The display device of claim 8, wherein the first sub-stage comprises a third transistor configured to discharge a voltage of an output node connected to the first output terminal to the low voltage in response to a signal synchronized with the first clock signal.

11. The display device of claim 8, wherein the first sub-stage comprises a fifteenth transistor configured to output the first clock signal as an n-th carry signal in response to a signal transmitted to the first control terminal of the first transistor.

12. The display device of claim 8, wherein the first sub-stage of the n-th stage further comprises:
a tenth transistor having a tenth control terminal configured to receive the first clock signal, a tenth input terminal connected to the first control terminal of the first transistor, and a tenth output terminal connected to the first output terminal of the first transistor;
an eleventh transistor configured to maintain a voltage applied to the first control terminal at a low voltage of a carry signal received from a (n−1)th stage in response to a second clock signal;
a fifth transistor configured to maintain a voltage applied to the first output terminal at the low voltage in response to the second clock signal;
a sixth transistor configured to maintain the voltage applied to the first control terminal at the low voltage in response to a reset signal; and
a ninth transistor configured to discharge the voltage applied to the first control terminal to the low voltage in response to a gate signal received from one of the next stages of the n-th stage.

13. The display device of claim 6, wherein the non-display area comprises first, second, third and fourth non-display areas respectively formed on the upper, lower, left and right sides of the display area, wherein the signal providing wiring line is located in the first non-display area and wherein the first sub-stage is located in the third non-display area or the fourth non-display area.

14. The display device of claim 13, wherein the at least one signal providing wiring line comprises a first signal providing wiring line extending in the first direction and configured to receive a first control signal, wherein the at least one signal delivering wiring line comprises a first signal delivering wiring line extending in the first direction, and wherein the at least one connection wiring line comprises at least one first connection wiring line extending in the second direction and connecting the first signal providing wiring line to the first signal delivering wiring line.

15. The display device of claim 14, wherein the first control signal is a first clock signal or a low voltage.

16. The display device of claim 14, wherein the at least one first connection wiring line comprises a plurality of first connection wiring lines, wherein the display device further comprises a first auxiliary wiring line extending in the first direction in the second non-display area and wherein the first auxiliary wiring line is connected to each of the first connection wiring lines.

17. The display device of claim 14, wherein the at least one signal providing wiring line further comprises at least one second signal providing wiring line extending in the first direction and configured to receive a second control signal different from the first control signal, wherein the at least one signal delivering wiring line comprises a second signal delivering wiring line extending in the first direction, and wherein the at least one connection wiring line further comprises at least one second connection wiring line extending in the second direction and connecting the second signal providing wiring line to the second signal delivering wiring line.

18. The display device of claim 17, wherein the first control signal is one of a first clock signal and a low voltage and wherein the second control signal is the other of the first clock signal and the low voltage.

19. The display device of claim 17, wherein the at least one second connection wiring line comprises a plurality of second connection wiring lines, wherein the display device further comprises a second auxiliary wiring line extending in the first direction in the second non-display area and wherein the second auxiliary wiring line is connected to each of the second connection wiring lines.

20. The display device of claim 6, further comprising a plurality of data lines extending in the second direction in the display area, wherein each of pixels comprises:
a first subpixel which includes a first subpixel electrode and a first pixel transistor; and
a second subpixel which includes a second subpixel electrode, a second pixel transistor and a third pixel transistor,
wherein the first pixel transistor comprises a control terminal connected to one of the gate lines, an input terminal connected to one of the data lines, and an output terminal connected to the first subpixel electrode,
wherein the second pixel transistor comprises a control terminal connected to the same gate line as the first pixel transistor, an input terminal connected to the sane data line as the first pixel transistor, and an output terminal connected to the second subpixel electrode, and
wherein the third pixel transistor comprises a control terminal connected to the same gate line as the first pixel transistor, an input terminal connected to the output terminal of the second pixel transistor, and an output terminal configured to receive a storage voltage.
